(19) United States
(12) Patent Application Publication
(10) Pub. No.: US 2024/0095320 A1
(43) Pub. Date: Mar. 21, 2024

(54) VOICE-ACTIVATED AUTHORIZATION TO ACCESS ADDITIONAL FUNCTIONALITY USING A DEVICE

(71) Applicant: Amazon Technologies, Inc., Seattle, WA (US)

(72) Inventors: Bharat Balasubramanya, Bothell, WA (US); Raveendra Kulakarni, Redmond, WA (US); Ramesh Aswath, Redmond, WA (US); Ashish Arora, Seattle, WA (US); Alexander Wenbo Zhou, Seattle, WA (US); Shyam Kumar, Seattle, WA (US)

(21) Appl. No.: 17/852,829

(22) Filed: Jun. 29, 2022

Related U.S. Application Data
(60) Provisional application No. 63/346,438, filed on May 27, 2022.

(51) Int. Cl. G06F 21/32; G06F 21/62; G10L 17/06; G10L 17/22

(52) U.S. Cl. CPC G06F 21/32; G06F 21/629; G10L 17/06; G10L 17/22

(57) ABSTRACT

Techniques for granting, for a device, access to additional functionality requested by user inputs received by the device are described. A system may receive, from a device, a first user input requesting content of a content type requiring additional functionality access in order for the content to be sent to the device. The system may exchange data with an access control system in order to determine the device is capable of performing the additional functionality. The system may prompt the user as to whether the additional functionality access should be granted. In response to receiving a confirmatory user input, the system may cause the access control system to grant the additional functionality access for the device.

### CROSS-REFERENCE TO RELATED APPLICATION

This application claims priority to U.S. Provisional Patent Application No. 63/346,438, filed May 27, 2022 and titled “VOICE-ACTIVATED DEVICE AUTHORIZATION TO ACCESS ADDITIONAL FUNCTIONALITY,” the content of which is expressly incorporated herein by reference in its entirety.

### BACKGROUND

Natural language processing systems have progressed to the point where humans can interact with computing devices using their voices and natural language textual input. Such systems employ techniques to identify the words spoken and written by a human user based on the various qualities of received input data. Speech recognition combined with natural language understanding processing techniques enable speech-based user control of computing devices to perform tasks based on the user's spoken inputs. Speech recognition and natural language understanding processing techniques may be referred to collectively or separately herein as spoken language understanding (SLU) processing. SLU processing may be used by computers, hand-held devices, telephone computer systems, kiosks, and a wide variety of other devices to improve human-computer interactions.

### BRIEF DESCRIPTION OF DRAWINGS

For a more complete understanding of the present disclosure, reference is now made to the following description taken in conjunction with the accompanying drawings.

FIG. 1 is a conceptual diagram illustrating a system for granting, for a device, access to additional functionality requested by user inputs received by the device, according to embodiments of the present disclosure.

FIG. 2 is a conceptual diagram illustrating example processing performable to grant, for the device, access to the additional functionality, according to embodiments of the present disclosure.

FIG. 3 is a conceptual diagram illustrating further example processing performable for grant, to the device, access to the additional functionality, according to embodiments of the present disclosure.

FIG. 4 is a conceptual diagram illustrating further example processing performable for grant, to the device, access to the additional functionality, according to embodiments of the present disclosure.

FIG. 5 is a conceptual diagram illustrating example system components that may be used to process a user input, according to embodiments of the present disclosure.

FIG. 6 is a schematic diagram of an illustrative architecture in which sensor data is combined to recognize one or more users, according to embodiments of the present disclosure.

FIG. 7 is a system flow diagram illustrating an example of speech-based user recognition processing, according to embodiments of the present disclosure.

FIG. 8 is a conceptual diagram of components of a device, according to embodiments of the present disclosure.

FIG. 9 is a block diagram conceptually illustrating example components of a device, according to embodiments of the present disclosure.

FIG. 10 is a block diagram conceptually illustrating example components of a system, according to embodiments of the present disclosure.

FIG. 11 illustrates an example of a computer network for use with the overall system, according to embodiments of the present disclosure.

### DETAILED DESCRIPTION

Automatic speech recognition (ASR) processing is concerned with transforming audio data including speech into a token or other textual representation of that speech. Similarly, natural language understanding (NLU) processing is concerned with enabling computers to derive meaning from natural language user inputs (such as spoken inputs). ASR processing and NLU processing are often used together as part of a spoken language processing component of a system. Text-to-speech (TTS) processing is concerned with transforming textual and/or other data into audio data that is synthesized to resemble human speech. Natural language generation (NLG) processing is concerned with automatically transforming data into natural language (e.g., English) content.

A system may further be configured to perform actions responsive to spoken natural language user inputs (i.e., utterances). For example, for the spoken natural language user input “play music by [artist name],” the system may output music sung by the indicated artist. For further example, for the spoken natural language user input “roll down the driver's window,” the system may roll down a driver's window of a vehicle that captured the spoken natural language user input. In another example, for the spoken natural language user input “what is today's weather,” the system may output synthesized speech of weather information based on where the user is located.

A vehicle, and more particularly a vehicle's head unit, may be configured to communicate with the foregoing system for the purpose of processing spoken natural language user inputs. A vehicle's “head unit,” sometimes referred to as an infotainment system, is a computing component of the vehicle that provides a unified hardware interface, including screens, buttons, and controls for various integrated information and entertainment functions of the vehicle.

To respond to a spoken natural language user input received by the vehicle, the system may need to send data to the vehicle for presentment to the user. For example, if the spoken natural language user input requests output of music, the system may need to send audio data, corresponding to the requested music, and optionally image data corresponding to an album cover and the like, to the vehicle for presentment. For further example, if the spoken natural language user input requests weather information, the system may need to send audio data, including synthesized speech corresponding to the requested weather information, and optionally image data corresponding to the requested weather information, to the vehicle for presentment. In another example, if the spoken natural language user input requests traffic information, the system may need to send audio data, including synthesized speech corresponding to the present traffic information for the vehicle's location, and optionally image data corresponding to the traffic information, to the vehicle for presentment. For further example, if the spoken natural language user input requests output of a podcast, the system may need to send audio data corresponding to the requested podcast, and optionally image data corresponding to the requested podcast, to the vehicle for presentment.

The device and system may exchange data via an access control system. As used herein, an “access control system” refers to a system configured to receive data (e.g., audio data, text data, video data, data usable to update a machine learning model running on the device, data for performing over-the-air updates, diagnostic/monitoring/control data, etc.) from a source device, and route said data to a target destination, and vice versa. For example, in the context of the device being a vehicle, the access control system may be a cellular network system configured to control the exchange of data with the vehicle via cellular data transmissions, and exchange of data with the system via Internet data transmissions.

The access control system may require that a device be authorized to access additional functionality (e.g., receive one or more types of data), before the access control system allows for the additional functionality to be provided to the device via the access control system (e.g., transmittal of the one or more types of data between the device and the system via the access control system). For example, the access control system may be configured to receive certain audio data including synthesized speech from the system, and send said audio data to the device without requiring authorization to access additional functionality, but may require such authorization if long-form audio data (e.g., corresponding to music, a podcast, video, etc.) is to be sent to the device on behalf of the system. In some embodiments, authorization to access additional functionality may need be purchased for the device. Authorization, from the access control system, to access additional functionality may further be obtained by the device based on a device identifier, a user profile, a purchase, an IP address, and/or a MAC address associated with the device.

The present disclosure provides, among other things, techniques for granting, to a device (e.g., a vehicle) and by an access control system, access to additional functionality requested by user's of the device. Although the examples provided herein use the example of a vehicle, the techniques described herein may apply to a number of different device-types, depending on system configuration. As can be appreciated, the device may have the capability to obtain authorization from one or more specific access control systems and for one or more specific functionalities, and the techniques described herein may apply to one or a number of different specific functionalities. For example, the access control system may be a captive portal in a commercial residence (e.g., a hotel), where the captive portal may authorize access to additional functionality (e.g., internet access) for a device (e.g., smart phone, laptop, smart TV, etc.) based on a device identifier, user profile, IP address, MAC address, and/or a purchase associated with the device. For further example, the access control system may be a home network configured with parental controls, where the home network may authorize access to additional functionality (e.g., internet access to specific content types) for a device (e.g. smart phone, laptop, smart TV, etc.) based on based on a device identifier, user profile, IP address, and/or MAC address associated with the device. For further example, the access control system may be a tiered content provider (e.g., Amazon Prime Video, Hulu, Netflix, etc.), where the tiered content provider may authorize access to additional functionality (e.g., access to specific content) for a device (e.g., smart phone, laptop, smart TV, etc.) based on a device identifier, user profile, IP address, MAC address, and/or a purchase associated with the device.

According to the present disclosure, the system may determine that a first spoken natural language user input, received from a device, requests output of a content type. The system may determine that additional functionality access, from an access control system, is required in order for the device to be permitted to output the content type. For example, the system may determine that the additional functionality access is required based at least in part on the device corresponding to a particular device type (e.g., vehicle). For further example, the system may determine that the additional functionality access is required based on the type of functionality requested. The system may determine that the device does not presently have authorization to access the additional functionality from the access control system. For example, the system may determine that state data, associated with the device, indicates that the device has not received the authorization from the access control system.

After determining that the device has not received the authorization from the access control system to access the additional functionality requested, the system may query the access control system for information pertaining to receiving the additional functionality access for the device. For example, the system may generate and send, to the access control system, an access token corresponding to profile data of the device (and/or the instant user).

The access control system may use the access token to receive the profile data, and may use the profile data to determine the device is a capable of performing the functionality requiring additional access. In response to this determination, the access control system may send, to the system, data indicating the device is capable of accessing the additional functionality, as well as additional functionality access information (e.g., pricing information) for accessing the additional functionality. The system may cause the device to output synthesized speech and/or display one or more images indicating additional functionality access is required to output the content type, the additional functionality access information, and a request for authorization to obtain the additional functionality access on the user's behalf.

After causing the foregoing output, the system may receive, from the device, a second spoken natural language user input requesting that additional functionality access be granted. In response to receiving the second spoken natural language user input, the system may request the additional functionality access from the access control system. Thereafter, the system may receive, from the access control system, an indication that the additional functionality access has been granted, and may cause the device to output, to the user, synthesized speech and/or display one or more images indicating that the additional functionality access has been granted.

In some embodiments, the system may determine a user identifier associated with the second spoken natural language user input, determine the user identifier is authorized to be used to obtain the additional functionality access (e.g., based on the user identifier being associated with or represented in the device's profile data), and, in response thereto, may obtain the additional functionality access from the access control system.

In some embodiments, after determining that the state data indicates the device has not been granted additional functionality access, the system may determine a number of user inputs (e.g., spoken natural language user inputs) that were received from the device and were unable to be performed based on the device not having been granted the additional functionality access. In response to determining the number of user inputs satisfies a condition (e.g., a threshold of number of spoken natural language user inputs), the system may generate the access token enabling the access control system to access the profile data of the device (and/or the instant user). Such a determination may be helpful in preventing the user from being so queried such that the user experience is degraded.

In some embodiments, the system may receive, from a device, a spoken natural language user input specifically requesting the additional functionality access be granted. The system may determine, using state data associated with the device, that additional functionality access has not been granted to the device. The system may query the access control system for additional functionality access information for the device. For example, the system may generate and send, to the access control system, an access token corresponding to profile data of the device (and/or the user). The system may receive the additional functionality access information and an indication that the device is capable of accessing the additional functionality from the access control system. The system may cause the device to output synthesized speech and/or display one or more images indicating the additional functionality access information, and a request for authorization to obtain the additional functionality access on the user's behalf.

After causing the foregoing output, the system may receive, from the device, a second spoken natural language user input authorizing the additional functionality access to be obtained on the user's behalf. In response to receiving the second spoken natural language user input, the system may request the additional functionality access from the access control system. Thereafter the system may receive, from the access control system, an indication that the additional functionality access has been granted, and may cause the device to output, to the user, synthesized speech and/or display one or more images indicating that the additional functionality access has been granted.

Teachings of the present disclosure provide an improved user experience, among other things. For example, the present disclosure improves the user experience by permitting a user to interact with and authorize a system to obtain (from an access control system) access to additional functionality for the user's device (e.g., a vehicle) on a user's behalf. Aspects of the present disclosure minimize the number of user/system interactions needed for access to additional functionality to be granted for a device by an access control system.

A system according to the present disclosure may be configured to incorporate user permissions and may only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

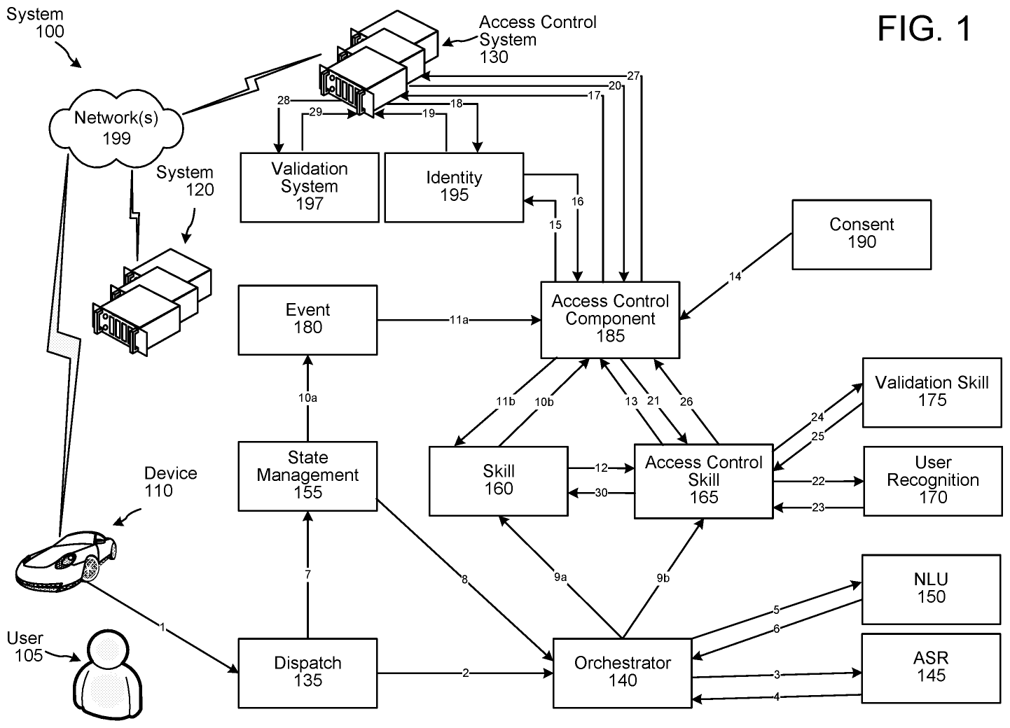

FIG. 1 illustrates a system 100 for granting, to a device, access to additional functionality requested by spoken natural language user inputs received by the device. The system 100 may include a device 110 (local to a user 105), a system 120, and an access control system 130 in communication via a network(s) 199 (at least a portion of which is provided by the access control system 130). While the device 110 is illustrated as being a vehicle, it will be appreciated that the present disclosure is applicable to any device configured to receive spoken natural language user inputs and which may require additional functionality access (from the access control system 130) to access particular functionality with respect to the system 120. The network(s) may include the Internet and/or any wide- or local-area network, and may include wired, wireless, satellite, and/or cellular network hardware.

The system 100 may include various components. With reference to FIG. 1, the system 100 may include a dispatch component 135, an orchestrator component 140, an automatic speech recognition (ASR) component 145, a natural language understanding (NLU) component 150, a state management component 155, a skill component 160, an access control skill component 165, a user recognition component 170, a validation skill component 175, an event component 180, an access control component 185, a consent component 190, an identity component 195, and a validation system 197 (in communication with the validation skill component 175). Although the figures illustrate the components in a particular arrangement, one skilled in the art will appreciate that different combinations and/or arrangements of the components are possible depending on the system's configuration without departing from the present disclosure. Further, in some embodiments, a subset of or all of the abovementioned components may be included in the system 120.

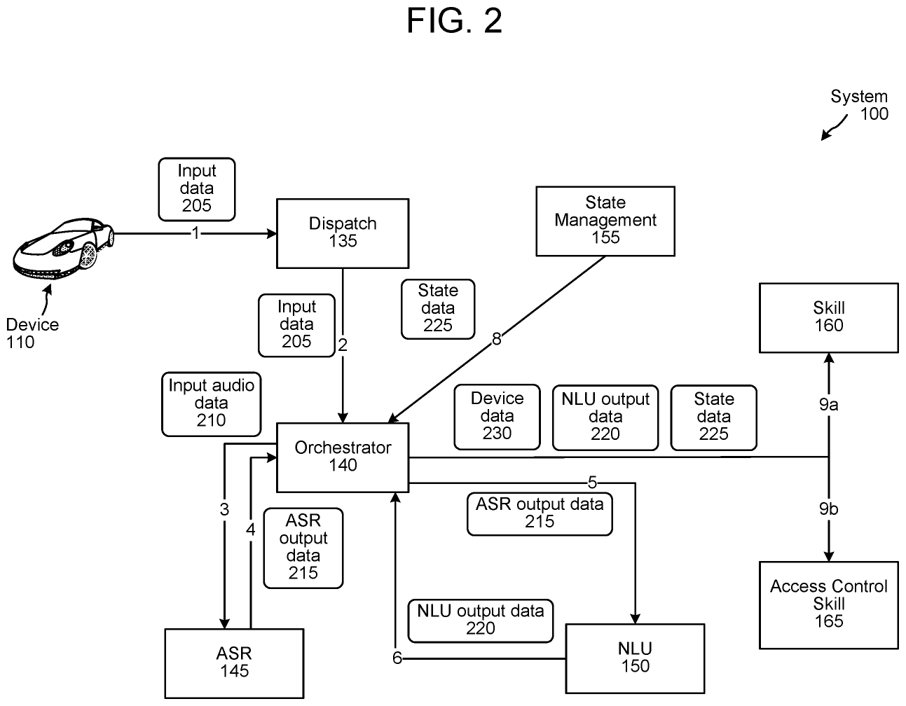

With reference to FIGS. 1 and 2 (noting steps 1-9b in FIG. 2 correspond to steps 1-9b of FIG. 1), the device 110 (via one or more microphones or via a connection with another device having one or more microphones such as another device wirelessly connected to a vehicle) may receive input audio of a spoken natural language user input of the user 105. The device 110 may generate input audio data, corresponding to the input audio. Alternatively, the device 110 may receive the user input in the form of a selection of a graphical user interface (GUI) button, a gesture, typed natural language text, etc.)

The device 110 may generate input data 205 to include the input audio data (or data representing the other type of user input received) and one or more other instances of data such as, but not limited to, a device identifier corresponding to the device 110 and/or time data corresponding to timing of receipt of the spoken natural language user input and/or generation of the input data.

The device 110 may send (via the network(s) 199 and at step 1) the input data 205 to the dispatch component 135. The dispatch component 135 may be configured to send (at step 2), the input data 205 to the orchestrator component 140.

In the situation wherein the input data 205 includes input audio data of a spoken natural language user input, the orchestrator component 140 may identify the input audio data 210 (included in the input data 205) and send (at step 3) the input audio data 210 to the ASR component 145.

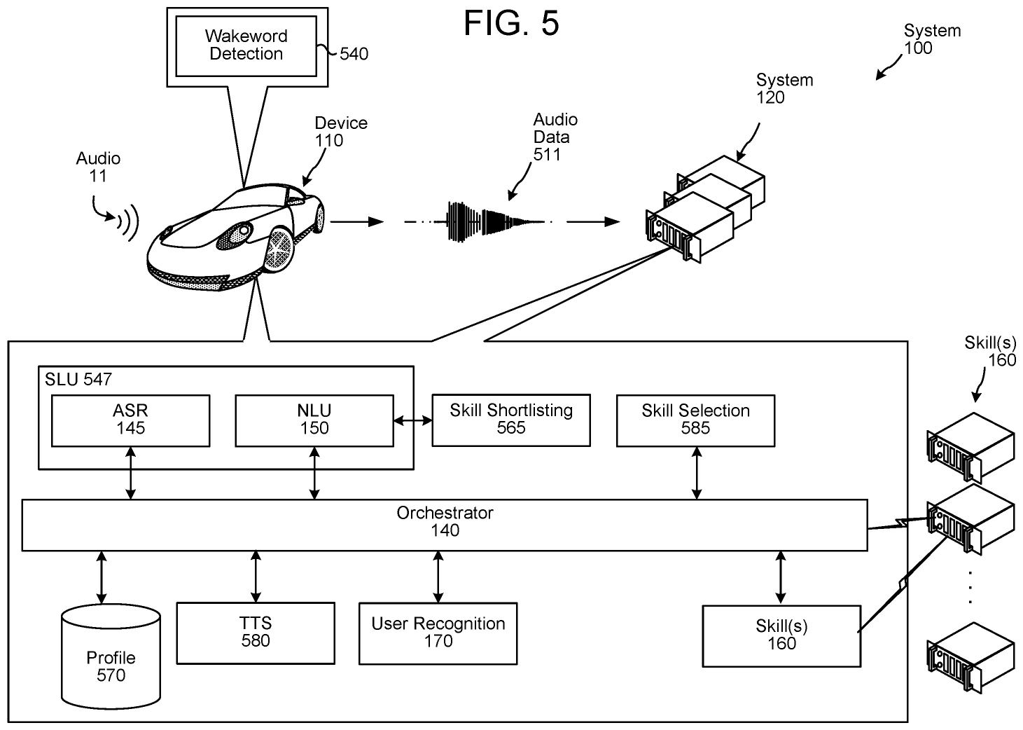

The ASR component 145 is configured to process the input audio data 210 to generate ASR output data 215 corresponding to the spoken natural language user input included in the input audio data 210. Processing of the ASR component 145 is described in detail herein below with respect to FIG. 5. The ASR output data 215 may include text or some other (e.g., tokenized) representation of the spoken natural language user input. For example, the ASR output data 215 may represent a transcription of the input audio data 210. The ASR component 145 may send (at step 4) the ASR output data 215 to the orchestrator component 140, which may send (at step 5) the ASR output data 215 to the NLU component 150.

In the situation where the input data 205 includes input text data corresponding to a typed natural language user input, the orchestrator component 140 may identify the input text data (in the input data 205), and send the input text data to the NLU component 150.

The NLU component 150 is configured to process the ASR output data 215 (or input text data) and generate NLU output data 220. Processing of the NLU component 150 is described in detail herein below with respect to FIG. 5. The NLU output data 220 may include one or more NLU hypotheses, each representing a respective semantic interpretation of the ASR output data 215. For example, each NLU hypothesis may include an intent determined by the NLU component 150 to represent the spoken natural language user input as represented in the ASR output data 215. Each NLU hypothesis may also include one or more entity types and corresponding entity values corresponding to entities determined by the NLU component 150 as being referred to in the spoken natural language user input as represented in the ASR output data 215. The NLU component 150 may send (at step 6) the NLU output data 220 to the orchestrator component 140.

Alternatively, the orchestrator component 140 may send the input audio data to a spoken language understanding (SLU) component (of the system 100) configured to generate NLU output data from the input audio data, without generating ASR output data as an intermediate.

In instances wherein the input data 205 includes data representing the selection of a GUI button, the orchestrator component 140 may send such data to a GUI user input component configured to process the data and determine NLU output data (or other data) representing the user input and usable by a downstream skill component. In instances where the input data 205 includes data representing a gesture, the orchestrator component 140 may send such data to a gesture detection component configured to process the data and determine NLU output data (or other data) representing the user input and usable by a downstream skill component.

As mentioned previously, the system 100 may include a state management component 155. The state management component 155 is configured to maintain a record of a present state of the device 110. The device 110 may send (e.g., via the network(s) 199) state data 225 to the dispatch component 135, which may send the state data 225 (at step 7 in FIG. 1) to the state management component 155. The state data 225 represents at least an additional functionality access state of the device 110.

The device 110 may send state data to the dispatch component 135 whenever there is a state change associated with the device 110. For example, a state change may occur when the device 110 is powered on (e.g., ignition of a vehicle housing the device 110). In this example, when the device 110 is powered on, the device 110 may send state data to the dispatch component 135 indicating the device 110 is in a powered on state, as well as indicating a level of functionality access (e.g., access to standard functionalities or access to additional functionalities) the device 110 has. As another example, a state change may occur when a level of functionality access of the device 110 changes. In this example, the state data may indicate the new functionality access status of the device. In some embodiments, the device 110 may be configured to send state data (representing at least a present functionality access status for the device 110) as part of the input data 205.

The state management component 155 may be configured to receive the state data 225 (at step 7 illustrated in FIG. 1) and update the device identifier of the device 110 to be associated with the current functionality access state. For example, the functionality access state may be <ConnectedWithNoAdditionalAccess>, or <ConnectedWithAdditionalAccess>.

Prior to or at least partially in parallel to at least one of the ASR component 145 and NLU component 150 processing, the orchestrator component 140 may identify the device identifier, represented in the input data 205, and may query (at step 8) the state management component 155 for state data 225 representing at least a present functionality access state of the device 110.

The orchestrator component 140 (or another component of the system 100, such as a skill selection component 585 illustrated in and described with respect to FIG. 5) may determine whether the NLU output data 220 includes an intent (or top scoring intent in the situation where the NLU output data 220 includes more than one NLU hypothesis) to obtain additional functionality access. If the orchestrator component 140 (or skill selection component 585) determines that the NLU output data 220 does not include an intent to obtain additional functionality access, then the orchestrator component 140 may send (at step 9a) device data 230 representing the device 110 (e.g., including a device identifier, such as a serial number, data representing a device type of the device 110, such as vehicle, etc.), the NLU output data 220, and the state data 225 to the skill component 160. Alternatively, if the orchestrator component 140 (or skill selection component 585) determines the NLU output data 220 includes an intent (or top scoring intent in the situation where the NLU output data 220 includes more than one NLU hypothesis) to obtain additional functionality access, then the orchestrator component 140 may send (at step 9b) the device data 230, the NLU output data 220, and the state data 225 to the access control skill component 165.

For example, if the NLU output data 220 includes an intent to play music, the skill component 160 may be a music skill component. For further example, if the NLU output data 220 includes an intent to output a podcast, the skill component 160 may be a podcast skill component. As another example, if the NLU output data 220 includes an intent to output weather information, the skill component 160 may be a weather skill. For further example, if the NLU output data 220 includes an intent to output traffic information, the skill component 160 may be a traffic skill component. As another example, if the NLU output data 220 includes an intent to book a restaurant reservation, the skill component 160 may be a restaurant reservation skill. One skilled in the art will appreciate that the foregoing use cases are not limiting, and that other types of intents and corresponding skill components are within the scope of the present disclosure.

As described above, the orchestrator component 140 may send the state data 225 to the skill component 160 (at step 9a) or the access control skill component 165 (at step 9b). In some embodiments, the orchestrator component 140 may send the state data 225 and the NLU output data 220 (an optionally the device data 230 and/or other data) to a policy component (not illustrated) configured to implement one or more policies for determining whether authorization to access additional functionality is required in order for the user input to be responded to. For example, the policy component may implement a policy indicating the foregoing additional functionality access is needed when the NLU output data 220 (or top scoring NLU hypothesis therein) includes a certain intent. For further example, the policy component may implement a policy indicating the aforementioned additional functionality access is not needed when the NLU output data 220 (or top scoring NLU hypothesis therein) includes a particular intent. As another example, the policy component may implement a policy indicating the additional functionality access is needed when the NLU output data 220 (or top scoring NLU hypothesis therein) includes a certain entity (or entity type). For further example, the policy component may implement a policy indicating additional functionality access is not needed when the NLU output data 220 (or top scoring NLU hypothesis therein) includes a particular entity (or entity type).

If the policy component determines additional functionality access is needed based on the NLU output data 220, the policy component may determine whether the state data 225 indicates said additional functionality access has already been authorized (e.g., determine whether the state data 225 indicates a present device state of <ConnectedWithNoAdditionalAccess> or <ConnectedWithAdditionalAccess>.

The policy component may generate and send, to the orchestrator component 140, policy evaluation data indicating whether or not additional functionality access is required. In this situation, the orchestrator component 140 may send the policy evaluation data (and not the state data 225) to the skill component 160 (at step 9a) or the access control skill component 165 (at step 9b).

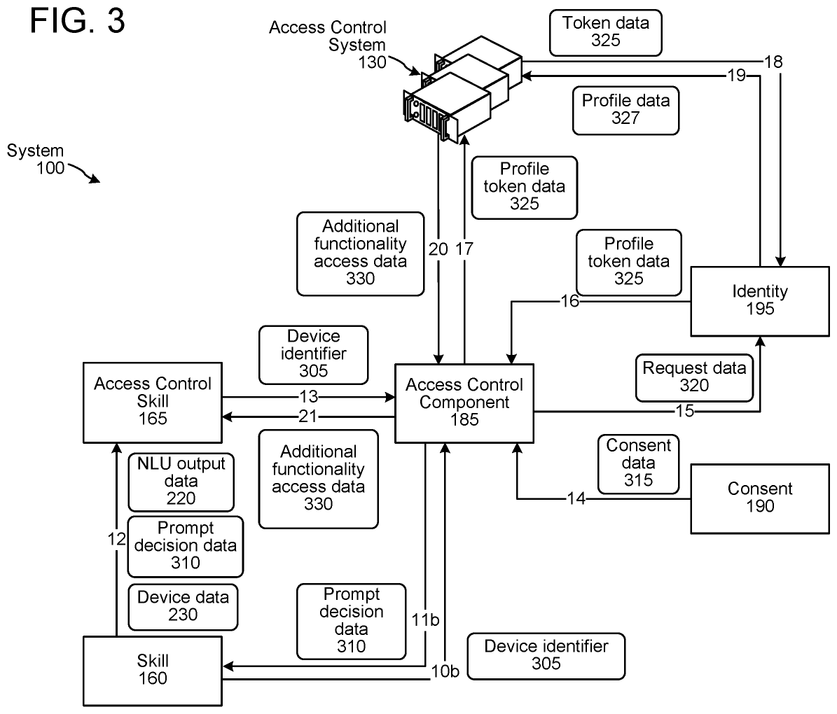

Referring now to FIGS. 1 and 3 (noting steps 10-22 in FIG. 3 correspond to step s10-22 in FIG. 1), after the skill component 160 receives the device data 230, the NLU output data 220, and the state data 225, the skill component 160 may determine whether the NLU output data 220 includes an intent whose performance requires additional functionality access.

The skill component 160 may determine whether performance of the intent requires additional functionality access in various ways. In some embodiments, the skill component 160 may make this determination based at least in part on the device data 230. For example, the skill component 160 may determine performance of the intent requires additional functionality access based at least in part on a device type included in the device data 230. As a specific example, the skill component 160 may determine additional functionality access is needed when the device data 230 indicates a vehicle device type. In some embodiments, the skill component 160 may determine that additional functionality access is needed when performance of the intent involves a particular type of functionality (e.g., outputting a type of data). In some embodiments, the skill component 160 may determine whether additional functionality access is needed for performance of an intent using an authorized functionality list. For example, the authorized functionality list may represent which intents may be performed by the skill component 160 when the additional functionality access is not active for the device 110. In some embodiments, the authorized functionality list may represent which intents may not be performed by the skill component 160 when the additional functionality access is not active for the device 110. For example, the skill component 160 may determine additional functionality access is needed when performance of the intent involves an intent to output long-form audio data (e.g., corresponding to music, a podcast, video, etc.). In some embodiments, the skill component 160 may determine additional functionality access is needed based on a combination of the device type and the type of functionality/intent (e.g., based on the intent requiring output of long-form audio data and the device type being a vehicle).

If the skill component 160 determines, based on the access state of the device, the intent, and the authorized functionality list, that the device 110 has been granted authorization to access the functionality required by the intent, the skill component 160 may execute the intent included in the NLU output data 220 (e.g., cause the long-form audio data to be sent to the device 110 for output). Alternatively, if the skill component 160 determines, based on the access state of the device, the intent, and the authorized functionality list, that the device 110 has not been granted the authorization necessary to access the functionality required by the intent, then the skill component 160 may send (at step 10b) the device identifier 305 (represented in the device data 230 as received by the skill component 160) to the access control component 185. In some embodiments, the skill component 160 may call the access control component 185 using an application program interface (API) for determining whether the user 105 should be queried to obtain (e.g., purchase) the additional functionality access for the device 110.

In embodiments where the skill component 160 receives the policy determination data discussed above with respect to FIG. 2, the skill component 160 may simply determine whether the policy determination data indicates additional functionality access is needed.

In response to receiving the device identifier 305, the access control component 185 may determine whether the user 105 is to be prompted to obtain the additional functionality access for the device 110. In some embodiments, the state management component 155 may send (at step 10a) the state data 225 to the event component, which may, in turn, send (at step 11a) the state data 225 to the access control component 185. The access control component 185 may implement one or more guardrail policies for determining whether the user 105 should be queried to obtain (i.e., purchase) the additional functionality access for the device 110. Such configuration of the access control component 185 may be helpful in preventing the user 105 from being so queried such that the user experience is degraded. For example, the access control component 185 may implement a policy that the device 110 should be caused to output a prompt, to obtain the additional functionality access for the device 110, no more than once every n number of user inputs requesting performance of an intent requiring functionality authorization not yet granted to the device 110. At runtime, to implement this policy, the access control component 185 may determine a number of previous user inputs that (i) were received from the device 110 corresponding to the device identifier 305 since the device 110 was last caused to output a prompt to obtain the additional functionality access and (ii) corresponded to one or more intents whose performance required additional functionality access not yet granted to the device 110. The access control component 185 may also determine whether the number of previous user inputs satisfies a condition (e.g., is equal to or greater than n number of user inputs). If the access control component 185 determines the number of previous user inputs satisfies the condition, then the access control component 185 may send (at step 11b), to the skill component 160, prompt decision data 310 representing the device 110 is to be caused to output a prompt querying the user 105 as to whether the additional functionality access should be obtained. Alternatively, if the access control component 185 determines the number of previous user inputs does not satisfy the condition, then the access control component 185 may send (at step 11b), to the skill component 160, prompt decision data 310 representing the device 110 is not to be caused to output the prompt querying the user 105 as to whether the additional functionality access is to be obtained (and optionally instead a prompt is to be output indicating the additional functionality access is required to perform the functionality requested by the instant user input).

In the situation where the prompt decision data 310 indicates the device 110 should not output a prompt querying whether the additional functionality access should be obtained, processing with respect to the instant user input may cease upon the skill component 160 receiving the prompt decision data 310 (and the skill component 160 may optionally cause the device 110 to present synthesized speech and/or display one or more images indicating the additional functionality access is required to respond to the instant user input). In the situation where the prompt decision data 310 indicates the device 110 should output the prompt querying whether the additional functionality access should be obtained, the skill component 160 may send (at step 12) the NLU output data 220, the prompt decision data 310, and the device data 230 to the access control skill component 165.

As discussed herein above with respect to FIG. 2, the orchestrator component 140 may send the device data 230, the NLU output data 220, and the state data 225 (or policy determination data) to the access control skill component 165 at step 9b, rather than the skill component 160 at step 9a, depending on the intent (or top scoring intent) in the NLU output data 220. If the orchestrator component 140 sends the device data 230, the NLU output data 220, and the state data 225 (or policy determination component) to the access control skill component 165 at step 9b, then the access control skill component 165 may determine whether the state data 225 indicates that the additional functionality access has been granted for the device 110 (using the manner as described herein above with regard to the skill component 160). Regardless of whether the access control skill component 165 receives the data at step 9b or step 12, the access control skill component 165 may query (at step 13) the access control component 185 for additional functionality access information related to the device identifier 305. Such query may include the access control skill component 165 sending the device identifier 305 (of the device 110) to the access control component 185.

The access control component 185 may be configured to receive the device identifier 305 and determine additional functionality access information (e.g., information corresponding to the access control system 130, pricing information, and/or other information relevant for the user 105 to make an informed decision as to whether the user 105 wants to authorize the access control skill component 165 to obtain the additional functionality access for the device 110). In some embodiments, the additional functionality access information may be provided to the access control component 185 from the access control system 130.

In some embodiments, the access control component 185 may be configured to determine whether a user input, accepting a clickwrap agreement of the access control system 130, has been received from the device 110. When the access control skill component 165 receives such a user input, the consent component 190 may associate a device identifier (corresponding to the device from which the user input was received) with a flag or other indicator/data representing said acceptance of the clickwrap agreement. The access control component 185 may query the consent component 190 to determine whether the device identifier 305 is associated with a flag or other indicator/data representing the clickwrap agreement has been accepted via a user input received from the device 110. The consent component 190 may determine whether the device identifier 305 is associated with such a flag or other indicator/data, and send (at step 14), to the access control component 185, consent data 315 representing the determination of the consent component 190.

If the access control component 185 determines the consent data 315 indicates the user has accepted the clickwrap (or other) agreement (or in the situation where such consent data is not required), the access control component 185 may send (step 15), to the identity component 195, request data 320 to generate profile token data for device profile data (of the device 110) and/or user profile data (of the user 105). The identity component 195 may be configured to retrieve profile data from a profile storage (discussed in detail herein below with respect to FIG. 5). The profile data may include user profile data, corresponding to the user 105, and/or device profile data corresponding to the device 110.

The identity component 195 may be configured to generate profile token data 325 for accessing the profile data in a secure manner. For example, the identity component 195 may generate a JavaScript Object Notation (JSON) Web Token (JWT) including at least the profile data, and encrypt the JWT using an encryption method as known in the art/industry. In some embodiments, the encryption method may be an asymmetric encryption method (e.g., RSA 256). The identity component 195 may send (at step 16) the profile token data 325 to the access control component 185.

The access control component 185 may send (at step 17) the profile token data 325 to the access control system 130. In some embodiments, the access control component 185 may also send the consent data 315 to the access control system 130. In other embodiments, the access control component 185 may send a representation of the consent data 315 (e.g., data simply indicating whether or not the clickwrap agreement has been accepted, without indicating the specific device 110 or user 105) to the access control system 130.

After receiving the profile token data 325 (at step 18), the access control system 130 may send (at step 18) the profile token data 325 to the identity component 195. The identity component 195 may thereafter decrypt the profile token data 325 using an art-/industry-known decryption method to determine the corresponding profile data for the device 110 and/or the user 105. The identity component 195 may send (at step 19) the profile data 327 to the access control system 130.

The access control system 130 may use the profile data 327 to determine the device 110 is configured to perform the functionality requiring the additional functionality access. For example, the access control system 130 may determine the profile data 327 indicates the device 110 includes at least one hardware component capable of exchanging data with the access control system 130 via cellular data transmissions, such as a transmitter and receiver configured to communicate with a cellular tower). For further example, the access control system 130 may use the consent data 315 to determine that consent to the clickwrap agreement of the access control system 130 has been given, and based thereon determine that the device 110 may be provided with the additional functionality access.

The access control system 130 may determine additional functionality access data 330 for the device 110. The access functionality access data 330 may include various data. For example, the additional functionality access data 330 may include a monthly price, an amount of data permitted to be sent to the device 110 in a single month, etc. For further example, the additional functionality access data 330 may indicate the additional functionality permitted by obtaining the additional functionality access. The access control system 130 may send (at step 20) the additional functionality access data 330 to the access control component 185. The access control component 185 may, in turn, send (at step 21) the additional functionality access data 330 to the access control skill component 165.

The access control skill component 165 may be configured to cause output audio data (including synthesized speech), representing the additional functionality access data 330, to be generated. For example, and while not illustrated in FIG. 3, the access control skill component 165 may send the additional functionality access data 330, along with a name of the access control system 130, to a natural language generation (NLG) component of the system 100. The natural language generation component may generate a natural language output based on the additional functionality access data 330 and name of the access control system 130. A text-to-speech (TTS) component of the system 100 (illustrated in and described in detail with respect to FIG. 5 herein below) may process the natural language output (of the natural language generation component) to generate the aforementioned output audio data including synthesized speech. The access control skill component 165 may also cause output image data to be generated, where the output image data indicates the additional functionality access data 330 and a name of the access control system 130. As an example, the synthesized speech may be “I'm sorry, but that action requires additional access, your vehicle is permitted to receive [amount of data] data a month for [subscription price] a month. Would you like me to purchase this for you?” or the like. Alternatively, if the access control system 130 determines the device 110 is not capable of performing the additional functionality, then the synthesized speech may be “I'm sorry, but your vehicle is not capable of supporting the requested functionality.” or the like. Alternatively, for further example where the access control system 130 determines the device 110 is capable of supporting the additional functionality access but the device 110 has not been used to accept a required clickwrap agreement of the access control system 130, then the synthesized speech may be “I'm sorry, but that action requires additional access, your vehicle is qualified to receive [amount of data] data a month for [subscription price] a month. If you would like me to purchase this for you, please indicate you accept the terms and conditions of access control system name.” or the like.

The access control skill component 165 may cause the output audio data (and optionally output image data) to be sent to the device 110 for presentment to the user 105. For example, the access control skill component 165 may send the output audio data (and optionally output image data) to the dispatch component 135, which may in turn send the output audio data (and optionally output image data) to the to the device 110 via the network(s) 199.

In response to receiving the output audio data (and optionally output image data, the device 110 may output audio corresponding to the output audio data (and optionally display one or more images corresponding to the output image data). In response thereto, the device 110 may receive audio of a spoken natural language user input from the user 105 (or some other type of user input, such as selection of a graphical user interface (GUI) button, gesture, etc.), and generate input audio data corresponding to the audio (or other type of input data corresponding to the user input).

The device 110 sends the input audio data (or other input data) to the dispatch component 135 for processing. For example, the device 110 may send the input audio data (or other input data) to the dispatch component 135 via the network(s) 199.

The dispatch component 135 may send the input audio data (or other input data) to the orchestrator component 140. In the situation where the orchestrator component 140 receives the input audio data, the orchestrator component 140 may send the input audio data to the ASR component 145. The ASR component 145 may process (as described in detail herein below with respect to FIG. 5) the input audio data to generate ASR output data corresponding to the spoken natural language user input. The ASR component 145 may send the ASR output data to the orchestrator component 140.

The orchestrator component 140 may send the ASR output data to the NLU component 150. The NLU component 150 may process (as described in detail herein below with respect to FIG. 5) the ASR output data to generate NLU output data including one or more NLU hypotheses representing the spoken natural language user input. The NLU component 150 may send the NLU output data to the orchestrator component 140.

Alternatively, the orchestrator component 140 may send the input audio data to a spoken language understanding (SLU) component (of the system 100) configured to generate NLU output data from the input audio data 405, without generating ASR output data as an intermediate.

The orchestrator component 140 may send the NLU output data (or other data representing the user input) to the access control skill component 165.

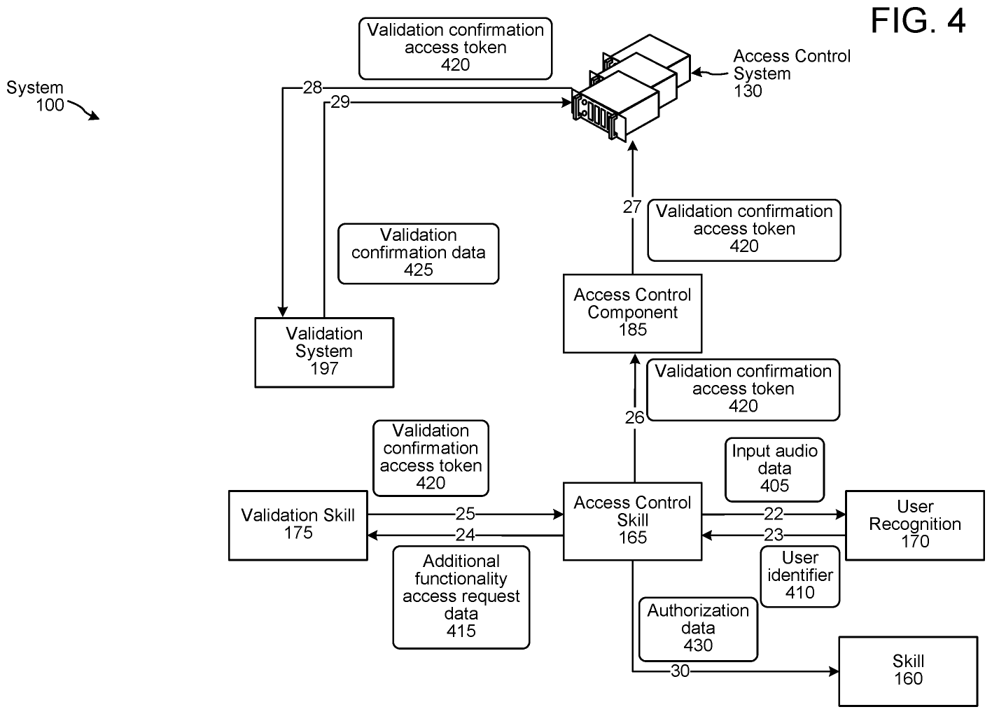

Referring to FIGS. 1 and 4 (noting steps 22-30 in FIG. 4 correspond to steps 22-30 in FIG. 1), the access control skill component 165 may determine whether the NLU output data (or other data representing the user input) indicates the user 105 has provided authorization to obtain the additional functionality access for the device 110. If the access control skill component 165 determines the NLU output data indicates the authorization has not been provided, the access control skill component 165 may cause processing to cease with respect to obtaining the additional functionality access. Conversely, if the access control skill component 165 determines the NLU output data indicates the authorization has been provided, then the access control skill component 165 may cause (at step 22) the input audio data 405 (of the instant user input) to be sent to the user recognition component 170 to determine an identity of the user 105. For example, the access control skill component 165 may send, to the orchestrator component 140, a request for user identity data, and the orchestrator component 140 may in turn send the input audio data 405 to the user recognition component 170.

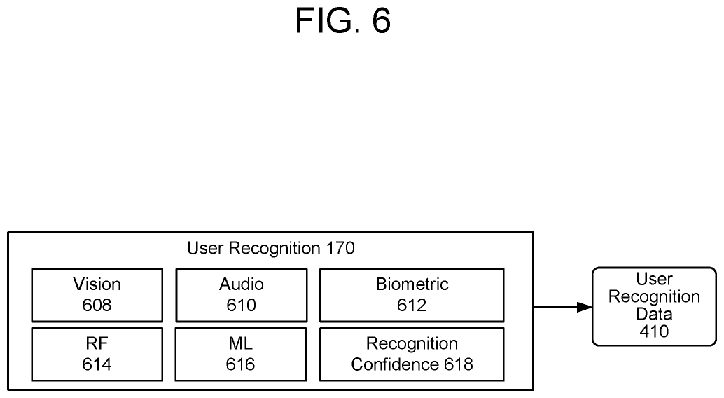

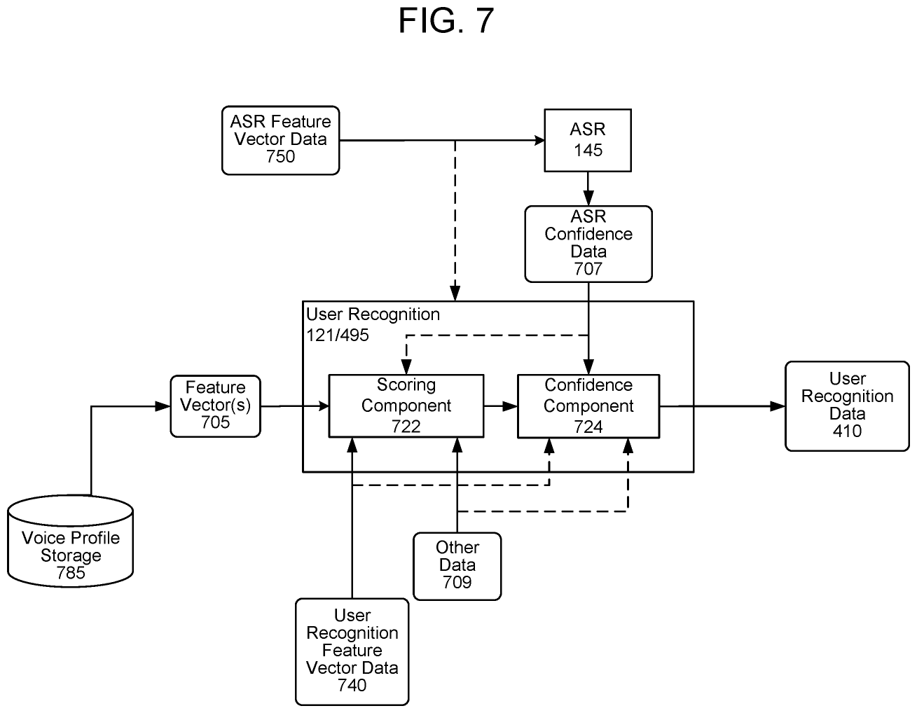

The user recognition component 170 is configured to receive the input audio data 405 and determine an identity of the user 105. Generally, the user recognition component 170 may process the input audio data 405 to determine speech characteristics represented therein, and may determine (in a storage of voice profiles, each corresponding to speech characteristics of a different user) a user identifier 410 corresponding to a voice profile corresponding to stored speech characteristics similar or identical to the speech characteristics determined in the input audio data. Further details for how the user recognition component 170 may process are described herein below with respect to FIGS. 6 and 7.

The user recognition component 170 may cause (at step 23) the user identifier 410 to be sent to the access control skill component 165. For example, the user recognition component 170 may send the user identifier 410 to the orchestrator component 140, and the orchestrator component 140 may send the user identifier 410 to the access control skill component 165.

The access control skill component 165 receives the user identifier 410 and may determine (using the user identifier 410) whether the user 105 is permitted to authorize the access control skill component 165 to cause the additional functionality access to be obtained for the device 110. For example, the access control skill component 165 may determine whether the user identifier 410 is associated with (or represented in) the device profile data of the device 110 (in other words, determine whether the device 110 is a registered device of the user 105). If the access control skill component 165 determines the user identifier 410 is not associated with (or represented in) the device profile data of the device 110 (in other words, determines the user 105 is not permitted to authorize the access control skill component 165 to cause the additional functionality access to be obtained for the device 110), the access control skill component 165 may cause processing to cease with respect to obtaining the additional functionality access. Conversely, if the access control skill component 165 determines the user identifier 410 is associated with (or represented in) the device profile data of the device 110 (in other words, determines user 105 is permitted to authorize the access control skill component 165 to cause the additional functionality access to be obtained for the device 110), the access control skill component 165 may determine additional functionality access request data 415 for use in conducting a payment transaction for the additional functionality access. In some embodiments, the additional functionality access request data 415 may include payment information (e.g., credit card information, address, etc.) from user profile data corresponding to the user identifier 410, and pricing information represented in the additional functionality access data 330 previously received by the access control skill component 165 at step 21. In some embodiments, the additional functionality access request data 415 may additionally include the user identifier 410. The access control skill component 165 may send (at step 24) the additional functionality access request data 415 to the validation skill component 175. In some embodiments, the access control skill component 165 may send the additional functionality access request data 415 to the orchestrator component 140, and the orchestrator component 140 may send the additional functionality access request data 415 to the validation skill component 175.

The validation skill component 175 is configured to receive the additional functionality access request data 415 and perform a payment transaction using the additional functionality access request data 415. For example, the validation skill component 175 may use the payment information (represented in the additional functionality access request data 415) to perform a payment transaction (for the price represented in the additional functionality access request data 415) with a computing system of a financial institution corresponding to the payment information (e.g., corresponding to credit card information represented in the additional functionality access request data 415). After conducting the foregoing payment transaction (amounting to purchase of the additional functionality access), the validation skill component 175 may generate a validation confirmation access token 420 for use in accessing payment confirmation data from the validation skill component 175. The validation skill component 175 may send (at step 25) the validation confirmation access token 420 to the access control skill component 165.

The access control skill component 165 may send (at step 26) the validation confirmation access token 420 to the access control component 185, which may, in turn, send (at step 27) the validation confirmation access token 420 to the access control system 130. The access control system 130 may send (at step 28) the validation confirmation access token 420 to the validation system 197.

In response to receiving the validation confirmation access token 420, the validation system 197 is configured to conduct a payment transaction with the access control system 130 (or a computing system of a financial institution associated with the access control system 130), in which the validation system 197 transfers the cost of the previous payment transaction (resulting in generation of the validation confirmation access token 420) to a payment account associated with the access control system 130. This payment transfer amounts to the user 105 purchasing the additional functionality access from the access control system 130. In some embodiments, the validation system 197 may be in communication with the validation skill component 175. For example, the validation system 197 may send the validation confirmation access token 420 to the validation skill component 175 and receive, from the validation skill component 175, a transfer of the cost of the previous payment transaction. The validation system 197 may generate validation confirmation data 425 representing the foregoing transfer of funds to the payment account of the access control system 130. The validation system 197 may send (at step 29) the validation confirmation data 425 to the access control system 130.

As a result of receiving the validation confirmation data 425, the access control system 130 may recognize as permissible sending of one or more types of data (e.g., long-form audio data) to the device 110. For example, the access control system 130 may recognize as permissible “higher bandwidth” data transmissions between the device 110 and the system 120. For further example, the access control system 130 may recognize as permissible the transmission of particular types of content between the device 110 and the skill component 160 and/or a different component of the system 120.

In some embodiments, the access control system 130 may generate authorization data representing the additional functionality access has been granted for the device 110, and may send the authorization data to the access control component 185, which may send the authorization data to the access control skill component 165. In some embodiments, in response to receiving the authorization data, the access control skill component 165 may cause the device 110 to output audio and/or display text and/or one or more images indicating the additional functionality access has been granted.

In some embodiments, after sending the validation confirmation access token 420 to the access control component 185 (and optionally after receiving the aforementioned authorization data), the access control skill component 165 may send (at step 30) authorization data 430 to the skill component 160, where the authorization data 430 indicates the additional functionality access has been granted for the device 110. In response to receiving the authorization data 430, the skill component 160 may cause output data (corresponding to the spoken natural language user input received at step 1) to be sent to the device 110 for presentment to the user 105.

In some embodiments the access control skill component 165 may not send the authorization data 430 the skill component 160. Rather, sometime after the access control system 130 receiving the validation confirmation data 425 at step 29, the access control system 130 may cause the state data (in the state management component 155) for the device 110 to indicate the additional functionality access is active for the device 110, and the device 110 may be caused to output synthesized speech (generated using NLG and TTS processing) and/or display one or more images representing the additional functionality access has been granted. As a result, if the device 110 thereafter again receives the spoken natural language user input previously received at step 1, the skill component 160 (or the herein described policy component) will determine the additional functionality access is active for the device 110, and cause the output data to be presented.

Although the access control skill component 165 has been described as causing the additional functionality access to be granted after outputting a single prompt to the user 105, in some embodiments the access control skill component 165 may output more than one prompt prior to causing the additional functionality access to be granted. For example, in response to the access control skill component 165 receiving the prompt decision data 310 at step 12, the access control skill component 165 may cause the device 110 to output audio (including synthesized speech) and/or display one or more images representing that a response to the spoken natural language user input received at step 1 requires additional functionality access, and querying the user 105 as to whether the user 105 would like to receive information about the additional functionality access. If the user responds affirmatively (e.g., via a spoken natural language user input), the access control skill component 165 may then process as described herein above to cause the additional functionality access data 330 to be granted by the access control system 130. Then, the access control skill component 165 may cause the device 110 to output audio (including synthesized speech) and/or display one or more images indicating the additional functionality access data 330, and querying the user 105 as to whether the user 105 would like the additional functionality access to be granted for the device 110. The system 100 may thereafter process as described herein above with respect to FIG. 4.

In some instances, the user 105 may no longer possess the device 110 (e.g., through sale, loss of the device 110, etc.), and may want to cancel the aforementioned additional functionality access granted for the device 110. In such instances, the user 105 may provide a user input (e.g., touch input via a touchscreen, spoken natural language input, etc.) indicates the additional functionality access should be terminated. The system 120 may process the user input (using ASR processing, NLU processing, SLU processing, touch input processing, etc.) to determine the user input requests the additional functionality access be terminated. As a result, the system 120 may send NLU output data (or other data representing the user input) to the access control skill component 165. In response to receiving the NLU output data (or other data representing the user input), the access control skill component 165 may send, to the access control component 185, a command to terminate the additional functionality access for the device 110. Such command may include the device identifier of the device 110. In response to receiving the command, the access control component 185, may send, to the access control system 130, a command to terminate the additional functionality access for the device 110. Such command may include the device identifier of the device 110. In response to receiving the command from the access control component 185, the access control system 130 may no longer recognize as permissible sending of one or more types of data (e.g., long-form audio data) to the device 110, may no longer recognize as permissible “higher bandwidth” data transmissions between the device 110 and the system 120, may no longer recognize as permissible the transmission of particular types of content between the device 110 and the skill component 160 and/or a different component of the system 120, etc. In addition, in response to receiving the user input requesting termination of the additional functionality access, the access control skill component 165 and/or the access control component 185 may cause the state management component 155 to update the state data of the device 110 to indicate the additional functionality access is no longer active for the device 110.

Referring now to FIG. 5, the following describes example components, of a system 100 that may be used to process a user input. The user 105 may speak an input, and the device 110 may receive audio 11 representing the spoken user input. For example, the user 105 may say “Alexa, what is the weather” or “Alexa, book me a plane ticket to Seattle.” In other examples, the user 105 may provide another type of input (e.g., selection of a button, selection of one or more displayed graphical interface elements, perform a gesture, etc.). The device 110 may send input data to a system 120 for processing. In examples where the user input is a spoken user input, the input data may be audio data 511. In other examples, the input data may be text data, or image data.

In the example of a spoken user input, a microphone or array of microphones (of or otherwise associated with the device 110) may continuously capture the audio 11, and the device 110 may continually process audio data, representing the audio 11, as it is continuously captured, to determine whether speech is detected. The device 110 may use various techniques to determine whether audio data includes speech. In some examples, the device 110 may apply voice activity detection (VAD) techniques. Such techniques may determine whether speech is present in audio data based on various quantitative aspects of the audio data, such as the spectral slope between one or more frames of the audio data, the energy levels of the audio data in one or more spectral bands, the signal-to-noise ratios of the audio data in one or more spectral bands, or other quantitative aspects. In other examples, the device 110 may implement a classifier configured to distinguish speech from background noise. The classifier may be implemented by techniques such as linear classifiers, support vector machines, and decision trees. In still other examples, the device 110 may apply Hidden Markov Model (HMM) or Gaussian Mixture Model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Once speech is detected in the audio data representing the audio 11, the device 110 may determine if the speech is directed at the device 110. In some embodiments, such determination may be made using a wakeword detection component. The wakeword detection component may be configured to detect various wakewords. In at least some examples, each wakeword may correspond to a name of a different digital assistant. An example wakeword/digital assistant name is “Alexa.”

Wakeword detection is typically performed without performing linguistic analysis, textual analysis, or semantic analysis. Instead, the audio data, representing the audio 11, is analyzed to determine if specific characteristics of the audio data match preconfigured acoustic waveforms, audio signatures, or other data corresponding to a wakeword.

Thus, the wakeword detection component may compare the audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMIs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 540 may be built on deep neural network (DNN)/recursive neural network (RNN) structures directly, without HMM being involved. Such an architecture may estimate the posteriors of wakewords with context data, either by stacking frames within a context window for DNN, or using RNN. Follow-on posterior threshold tuning or smoothing is applied for decision making. Other techniques for wakeword detection, such as those known in the art, may also be used.

Once the wakeword detection component detects a wakeword, the device 110 may “wake” and send, to the system 120, the input audio data 511 representing the spoken user input.

The system 120 may include the orchestrator component 140 configured to, among other things, coordinate data transmissions between components of the system 120. The orchestrator component 140 may receive the audio data 511 from the device 110, and send the audio data 511 to an ASR component 145.

The ASR component 145 transcribes the audio data 511 into ASR output data including one or more ASR hypotheses. An ASR hypothesis may be configured as a textual interpretation of the speech in the audio data 511, or may be configured in another manner, such as one or more tokens. Each ASR hypothesis may represent a different likely interpretation of the speech in the audio data 511. Each ASR hypothesis may be associated with a score (e.g., confidence score, probability score, or the like) representing the associated ASR hypothesis correctly represents the speech in the audio data 511.

The ASR component 145 interprets the speech in the audio data 511 based on a similarity between the audio data 511 and pre-established language models. For example, the ASR component 145 may compare the audio data 511 with models for sounds (e.g., subword units, such as phonemes, etc.) and sequences of sounds to identify words that match the sequence of sounds of the speech represented in the audio data 511.

In at least some instances, instead of the device 110 receiving a spoken natural language user input, the device 110 may receive a textual (e.g., typed) natural language user input. The device 110 may determine text data representing the textual natural language user input, and may send the text data to the system 120, wherein the text data is received by the orchestrator component 140. The orchestrator component 140 may send the text data or ASR output data, depending on the type of natural language user input received, to the NLU component 150.

The NLU component 150 processes the ASR output data or text data to determine one or more NLU hypotheses embodied in NLU output data. The NLU component 150 may perform intent classification (IC) processing on the ASR output data or text data to determine an intent of the natural language user input. An intent corresponds to an action to be performed that is responsive to the natural language user input. To perform IC processing, the NLU component 150 may communicate with a database of words linked to intents. For example, a music intent database may link words and phrases such as “quiet,” “volume off,” and “mute” to a <Mute> intent. The NLU component 150 identifies intents by comparing words and phrases in ASR output data or text data to the words and phrases in an intents database. In some embodiments, the NLU component 150 may communicate with multiple intents databases, with each intents database corresponding to one or more intents associated with a particular skill.

For example, IC processing of the natural language user input “play my workout playlist” may determine an intent of <PlayMusic>. For further example, IC processing of the natural language user input “call mom” may determine an intent of <Call>. In another example, IC processing of the natural language user input “call mom using video” may determine an intent of <VideoCall>. In yet another example, IC processing of the natural language user input “what is today's weather” may determine an intent of <OutputWeather>.

The NLU component 150 may also perform named entity recognition (NER) processing on the ASR output data or text data to determine one or more portions, sometimes referred to as slots, of the natural language user input that may be needed for post-NLU processing (e.g., processing performed by a skill). For example, NER processing of the natural language user input “play [song name]” may determine an entity type of “SongName” and an entity value corresponding to the indicated song name. For further example, NER processing of the natural language user input “call mom” may determine an entity type of “Recipient” and an entity value corresponding to “mom.” In another example, NER processing of the natural language user input “what is today's weather” may determine an entity type of “Date” and an entity value of “today.”

In at least some embodiments, the intents identifiable by the NLU component 150 may be linked to one or more grammar frameworks with entity types to be populated with entity values. Each entity type of a grammar framework corresponds to a portion of ASR output data or text data that the NLU component 150 believes corresponds to an entity value. For example, a grammar framework corresponding to a <PlayMusic> intent may correspond to sentence structures such as “Play {Artist Name},” “Play {Album Name},” “Play {Song name},” “Play {Song name} by {Artist Name},” etc.

For example, the NLU component 150 may perform NER processing to identify words in ASR output data or text data as subject, object, verb, preposition, etc. based on grammar rules and/or models. Then, the NLU component 150 may perform IC processing using the identified verb to identify an intent. Thereafter, the NLU component 150 may again perform NER processing to determine a grammar model associated with the identified intent. For example, a grammar model for a <PlayMusic> intent may specify a list of entity types applicable to play the identified “object” and any object modifier (e.g., a prepositional phrase), such as {Artist Name}, {Album Name}, {Song name}, etc. The NER processing may then involve searching corresponding fields in a lexicon, attempting to match words and phrases in the ASR output data that NER processing previously tagged as a grammatical object or object modifier with those identified in the lexicon.

NER processing may include semantic tagging, which is the labeling of a word or combination of words according to their type/semantic meaning. NER processing may include parsing ASR output data or text data using heuristic grammar rules, or a model may be constructed using techniques such as hidden Markov models, maximum entropy models, log linear models, conditional random fields (CRFs), and the like. For example, NER processing with respect to a music skill may include parsing and tagging ASR output data or text data corresponding to “play mother's little helper by the rolling stones” as {Verb}: “Play,” {Object}: “mother's little helper,” {Object Preposition}: “by,” and {Object Modifier}: “the rolling stones.” The NER processing may identify “Play” as a verb based on a word database associated with the music skill, which IC processing determines corresponds to a <PlayMusic> intent.

The NLU component 150 may generate NLU output data including one or more NLU hypotheses, with each NLU hypothesis including an intent and optionally one or more entity types and corresponding entity values. In some embodiments, the NLU component 150 may perform IC processing and NER processing with respect to different skills. One skill may support the same or different intents than another skill. Thus, the NLU output data may include multiple NLU hypotheses, with each NLU hypothesis corresponding to IC processing and NER processing performed on the ASR output or text data with respect to a different skill.

The skill shortlisting component 565 is configured to determine a subset of skill components, implemented by or in communication with the system 120, that may perform an action responsive to the (spoken) user input. Without the skill shortlisting component 565, the NLU component 150 may process ASR output data input thereto with respect to every skill component of or in communication with the system 120. By implementing the skill shortlisting component 565, the NLU component 150 may process ASR output data with respect to only the skill components the skill shortlisting component 565 determines are likely to execute with respect to the user input. This reduces total compute power and latency attributed to NLU processing.

The skill shortlisting component 565 may include one or more ML models. The ML model(s) may be trained to recognize various forms of user inputs that may be received by the system 120. For example, during a training period, a skill component developer may provide training data representing sample user inputs that may be provided by a user to invoke the skill component. For example, for a ride sharing skill component, a skill component developer may provide training data corresponding to “get me a cab to [location],” “get me a ride to [location],” “book me a cab to [location],” “book me a ride to [location],” etc.

The system 120 may use the sample user inputs, provided by a skill component developer, to determine other potentially related user input structures that users may try to use to invoke the particular skill component. The ML model(s) may be further trained using these potentially related user input structures. During training, the skill component developer may be queried regarding whether the determined other user input structures are permissible, from the perspective of the skill component developer, to be used to invoke the skill component. The potentially related user input structures may be derived by one or more ML models, and may be based on user input structures provided by different skill component developers.

The skill component developer may also provide training data indicating grammar and annotations.

Each ML model, of the skill shortlisting component 565, may be trained with respect to a different skill component. Alternatively, the skill shortlisting component 565 may implement one ML model per domain, such as one ML model for skill components associated with a weather domain, one ML model for skill components associated with a ride sharing domain, etc.

The sample user inputs provided by a skill component developer, and potentially related sample user inputs determined by the system 120, may be used as binary examples to train a ML model associated with a skill component. For example, some sample user inputs may be positive examples (e.g., user inputs that may be used to invoke the skill component). Other sample user inputs may be negative examples (e.g., user inputs that may not be used to invoke the skill component).

As described above, the skill shortlisting component 565 may include a different ML model for each skill component, a different ML model for each domain, or some other combination of ML models. In some embodiments, the skill shortlisting component 565 may alternatively include a single ML model. This ML model may include a portion trained with respect to characteristics (e.g., semantic characteristics) shared by all skill components. The ML model may also include skill component-specific portions, with each skill component-specific portion being trained with respect to a specific skill component. Implementing a single ML model with skill component-specific portions may result in less latency than implementing a different ML model for each skill component because the single ML model with skill component-specific portions limits the number of characteristics processed on a per skill component level.

The portion, trained with respect to characteristics shared by more than one skill component, may be clustered based on domain. For example, a first portion, of the portion trained with respect to multiple skill components, may be trained with respect to weather domain skill components; a second portion, of the portion trained with respect to multiple skill components, may be trained with respect to music domain skill components; a third portion, of the portion trained with respect to multiple skill components, may be trained with respect to travel domain skill components; etc.

The skill shortlisting component 565 may make binary (e.g., yes or no) determinations regarding which skill components relate to the ASR output data. The skill shortlisting component 565 may make such determinations using the one or more ML models described herein above. If the skill shortlisting component 565 implements a different ML model for each skill component, the skill shortlisting component 565 may run the ML models that are associated with enabled skill components as indicated in a user profile associated with the device 110 and/or the user 105.

The skill shortlisting component 565 may generate an n-best list of skill components that may execute with respect to the user input represented in the ASR output data. The size of the n-best list of skill components is configurable. In an example, the n-best list of skill components may indicate every skill component of, or in communication with, the system 120 as well as contain an indication, for each skill component, representing whether the skill component is likely to execute the user input represented in the ASR output data. In another example, instead of indicating every skill component, the n-best list of skill components may only indicate the skill components that are likely to execute the user input represented in the ASR output data. In yet another example, the skill shortlisting component 565 may implement thresholding such that the n-best list of skill components may indicate no more than a maximum number of skill components. In another example, the skill components included in the n-best list of skill components may be limited by a threshold score, where only skill components associated with a likelihood to handle the user input above a certain score are included in the n-best list of skill components.

The ASR output data may correspond to more than one ASR hypothesis. When this occurs, the skill shortlisting component 565 may output a different n-best list of skill components for each ASR hypothesis. Alternatively, the skill shortlisting component 565 may output a single n-best list of skill components representing the skill components that are related to the multiple ASR hypotheses represented in the ASR output data.

As indicated above, the skill shortlisting component 565 may implement thresholding such that an n-best list of skill components output therefrom may include no more than a threshold number of entries. If the ASR output data includes more than one ASR hypothesis, the n-best list of skill components may include no more than a threshold number of entries irrespective of the number of ASR hypotheses output by the ASR component 145. Additionally or alternatively, the n-best list of skill components may include no more than a threshold number of entries for each ASR hypothesis (e.g., no more than five entries for a first ASR hypothesis, no more than five entries for a second ASR hypothesis, etc.).

Additionally or alternatively to making a binary determination regarding whether a skill component potentially relates to the ASR output data, the skill shortlisting component 565 may generate confidence scores representing likelihoods that skill components relate to the ASR output data. The skill shortlisting component 565 may perform matrix vector modification to obtain confidence scores for all skill components in a single instance of processing of the ASR output data.

An n-best list of skill components including confidence scores that may be output by the skill shortlisting component 565 may be represented as, for example:
Story skill component, 0.67
Recipe skill component, 0.62
Information skill component, 0.57
Shopping skill component, 0.42

As indicated, the confidence scores output by the skill shortlisting component 565 may be numeric values. The confidence scores output by the skill shortlisting component 565 may alternatively be binned values (e.g., high, medium, low).

The n-best list of skill components may only include entries for skill components having a confidence score satisfying (e.g., meeting or exceeding) a minimum threshold confidence score. Alternatively, the skill shortlisting component 565 may include entries for all skill components associated with enabled skill components of the current user, even if one or more of the skill components are associated with confidence scores that do not satisfy the minimum threshold confidence score.

The skill shortlisting component XAA65 may consider other data when determining which skill components may relate to the user input represented in the ASR output data as well as respective confidence scores. The other data may include usage history data, data indicating the skill components that are enabled with respect to the device 110 and/or user 105, data indicating a device type of the device 110, data indicating a speed of the device 110, a location of the device 110, data indicating a skill component that was being used to output content via the device 110 when the device 110 received the instant user input, etc.

The thresholding implemented with respect to the n-best list of skill components generated by the skill shortlisting component 565 as well as the different types of other data considered by the skill shortlisting component 565 are configurable.

As described above, the system 120 may perform speech processing using two different components (e.g., the ASR component 145 and the NLU component 150). In at least some embodiments, the system 120 may implement a spoken language understanding (SLU) component 547 configured to process audio data 511 to determine NLU output data.

The SLU component 547 may be equivalent to a combination of the ASR component 145 and the NLU component 150. Yet, the SLU component 547 may process audio data 511 and directly determine the NLU output data, without an intermediate step of generating ASR output data. As such, the SLU component 547 may take audio data 511 representing a spoken natural language user input and attempt to make a semantic interpretation of the spoken natural language user input. That is, the SLU component 547 may determine a meaning associated with the spoken natural language user input and then implement that meaning. For example, the SLU component 547 may interpret audio data 511 representing a spoken natural language user input in order to derive a desired action. The SLU component 547 may output a most likely NLU hypothesis, or multiple NLU hypotheses associated with respective confidence or other scores (such as probability scores, etc.).

The system 120 may include a gesture detection component (not illustrated in FIG. 5). The system 120 may receive image data representing a gesture, and the gesture detection component may process the image data to determine a gesture represented therein. The gesture detection component may implement art-/industry-known gesture detection processes.

In embodiments where the system 120 receives non-image data (e.g., text data) representing a gesture, the orchestrator component 140 may be configured to determine what downstream processing is to be performed in response to the gesture.

The system may include a skill selection component 585 is configured to determine a skill component, or n-best list of skill components each associated with a confidence score/value, to execute to respond to the user input. The skill selection component 585 may include a skill component proposal component, a skill component pre-response component, and a skill component ranking component.

The skill component proposal component is configured to determine skill components capable of processing in response to the user input. In addition to receiving the NLU output data, the skill component proposal component may receive context data corresponding to the user input. For example, the context data may indicate a skill component that was causing the device 110 to output content (e.g., music, video, synthesized speech, etc.) when the device 110 captured the user input, one or more skill components that are indicated as enabled in a profile (as stored in the profile storage 570) associated with the user 105, output capabilities of the device 110, a geographic location of the device 110, and/or other context data corresponding to the user input.

The skill component proposal component may implement skill component proposal rules. A skill component developer, via a skill component developer device, may provide one or more rules representing when a skill component should be invoked to respond to a user input. In some embodiments, such a rule may be specific to an intent. In such embodiments, if a skill component is configured to execute with respect to multiple intents, the skill component may be associated with more than one rule (e.g., each rule corresponding to a different intent capable of being handled by the skill component). In addition to being specific to an intent, a rule may indicate one or more entity identifiers with respect to which the skill component should be invoked. For further example, a rule may indicate output capabilities of a device, a geographic location, and/or other conditions.

Each skill component may be associated with each rule corresponding to the skill component. As an example, a rule may indicate a video skill component may execute when a user input corresponds to a “Play Video” intent and the device includes or is otherwise associated with a display. As another example, a rule may indicate a music skill component may execute when a user input corresponds to a “PlayMusic” intent and music is being output by a device when the device captures the user input. It will be appreciated that other examples are possible. The foregoing rules enable skill components to be differentially proposed at runtime, based on various conditions, in systems where multiple skill components are configured to execute with respect to the same intent.

The skill component proposal component, using the NLU output data, received context data, and the foregoing described skill component proposal rules, determines skill components configured to process in response to the user input. Thus, in some embodiments, the skill component proposal component may be implemented as a rules engine. In some embodiments, the skill component proposal component may make binary (e.g., yes/no, true/false, etc.) determinations regarding whether a skill component is configured to process in response to the user input. For example, the skill component proposal component may determine a skill component is configured to process, in response to the user input, if the skill component is associated with a rule corresponding to the intent, represented in the NLU output data, and the context data.

In some embodiments, the skill component proposal component may make such binary determinations with respect to all skill components. In some embodiments, the skill component proposal component may make the binary determinations with respect to only some skill components (e.g., only skill components indicated as enabled in the user profile of the user 105).

After the skill component proposal component is finished processing, the skill component pre-response component may be called to execute. The skill component pre-response component is configured to query skill components, determined by the skill component proposal component as configured to process the user input, as to whether the skill components are in fact able to respond to the user input. The skill component pre-response component may take as input the NLU output data including one or more NLU hypotheses, where each of the one or more NLU hypotheses is associated with a particular skill component determined by the skill component proposal component as being configured to respond to the user input.

The skill component pre-response component sends a pre-response query to each skill component determined by the skill component proposal component. A pre-response query may include the NLU hypothesis associated with the skill component, and optionally other context data corresponding to the user input.

A skill component may determine, based on a received pre-response query and optionally other data available to the skill component, whether the skill component is capable of responding to the user input. For example, a skill component may generate a pre-response indicating the skill component can respond to the user input, indicating the skill component needs more data to determine whether the skill component can respond to the user input, or indicating the skill component cannot respond to the user input.

In situations where a skill component's pre-response indicates the skill component can respond to the user input, or indicating the skill component needs more information, the skill component's pre-response may also include various other data representing a strength of the skill component's potential response to the user input. Such other data may positively influence the skill component's ranking by the skill component ranking component of the skill selection component 585. For example, such other data may indicate capabilities (e.g., output capabilities or components such as a connected screen, loudspeaker, etc.) of a device to be used to output the skill component's response; pricing data corresponding to a product or service the user input is requesting be purchased or is requesting information for; availability of a product the user input is requesting be purchased; whether there are shipping fees for a product the user input is requesting be purchased; whether the user 105 already has a profile and/or subscription with the skill component; that the user 105 does not have a subscription with the skill component, but that there is a free trial/tier the skill component is offering; with respect to a taxi skill component, a cost of a trip based on start and end locations, how long the user 105 would have to wait to be picked up, etc.; and/or other data available to the skill component that is related to the skill component's processing of the user input. In some embodiments, a skill component's pre-response may include an indicator (e.g., flag, representing a strength of the skill component's ability to personalize its response to the user input).

In some embodiments, a skill component's pre-response may be configured to a pre-defined schema. By requiring pre-responses to conform to a specific schema (e.g., by requiring skill components to only be able to provide certain types of data in pre-responses), new skill components may be onboarded into the skill component selection functionality without needing to reconfigure the skill selection component 585 each time a new skill component is onboarded. Moreover, requiring pre-responses to conform to a schema limits the amount of values needed to be used to train and implement a ML model for ranking skill components.

In some embodiments, a skill component's pre-response may indicate whether the skill component requests exclusive display access (i.e., whether the skill component requests its visual data be presented on an entirety of the display).

After the skill component pre-response component queries the skill components for pre-responses, the skill component ranking component may be called to execute. The skill component ranking component may be configured to select a single skill component, from among the skill components determined by the skill component proposal component, to respond to the user input. In some embodiments, the skill component ranking component may implement a ML model. In some embodiments, the ML model may be a deep neural network (DNN).

The skill component ranking component may take as input the NLU output data, the skill component pre-responses, one or more skill component preferences of the user 105 (e.g., as represented in a user profile or group profile stored in the profile storage 570), NLU confidence scores of the NLU output data, a device type of the device 110, data indicating whether the device 110 was outputting content when the user input was received, and/or other context data available to the skill component ranking component.

The skill component ranking component ranks the skill components using the ML model. Things that may increase a skill component's ranking include, for example, that the skill component is associated with a pre-response indicating the skill component can generate a response that is personalized to the user 105, that a NLU hypothesis corresponding to the skill component is associated with a NLU confidence score satisfying a condition (e.g., a threshold NLU confidence score) that the skill component was outputting content via the device 110 when the device 110 received the user input, etc. Things that may decrease a skill component's ranking include, for example, that the skill component is associated with a pre-response indicating the skill component cannot generate a response that is personalized to the user 105, that a NLU hypothesis corresponding to the skill component is associated with a NLU confidence score failing to satisfy a condition (e.g., a threshold NLU confidence score, etc.).

The skill component ranking component may generate a score for each skill component determined by the skill component proposal component, where the score represents a strength with which the skill component ranking component recommends the associated skill component be executed to respond to the user input. Such a confidence score may be a numeric score (e.g., between 0 and 1) or a binned score (e.g., low, medium, high).

The system 120 may include or otherwise communicate with one or more skill components 160. A skill component 160 may process NLU output data and perform one or more actions in response thereto. For example, for NLU output data including a <PlayMusic> intent, an “artist” entity type, and an artist name as an entity value, a music skill component may output music sung by the indicated artist. For further example, for NLU output data including a <TurnOn> intent, a “device” entity type, and an entity value of “lights,” a smart home skill component may cause one or more “smart” lights to operate in an “on” state. In another example, for NLU output data including an <OutputWeather> intent, a “location” entity type, and an entity value corresponding to a geographic location of the device 110, a weather skill component may output weather information for the geographic location. For further example, for NLU output data including a <BookRide> intent, a taxi skill component may book a requested ride. In another example, for NLU output data including a <BuyPizza> intent, a restaurant skill component may place an order for a pizza. In another example, for NLU output data including an <OutputStory> intent and a “title” entity type and corresponding title entity value, a story skill component may output a story corresponding to the title.

A skill component may operate in conjunction between the device 110/system 120 and other devices, such as a restaurant electronic ordering system, a taxi electronic booking system, etc. in order to complete certain functions. Inputs to a skill component may come from speech processing interactions or through other interactions or input sources.

A skill component may be associated with a domain, a non-limiting list of which includes a smart home domain, a music domain, a video domain, a weather domain, a communications domain, a flash briefing domain, a shopping domain, and a custom domain.

The skill component 160 may process to determine output data responsive to the spoken user input (e.g., based on the intent and entity data as represented in the NLU output data received by the skill component 160).

The system 120 may include a TTS component 580 that generates audio data including synthesized speech. The TTS component 580 is configured to generate output audio data including synthesized speech. The TTS component 580 may perform speech synthesis using one or more different methods. In one method of synthesis called unit selection, the TTS component 580 matches a database of recorded speech against the data input to the TTS component 580. The TTS component 580 matches the input data against spoken audio units in the database. Matching units are selected and concatenated together to form a speech output. Each unit includes an audio waveform corresponding with a phonetic unit, such as a short .wav file of the specific sound, along with a description of the various acoustic features associated with the .wav file, such as its pitch, energy, etc., as well as other information, such as where the phonetic unit appears in a word, sentence, or phrase, the neighboring phonetic units, etc. Using all the information in the unit database, the TTS component 580 may match units to the input data to create a natural sounding waveform. The unit database may include multiple examples of phonetic units to provide the TTS component 580 with many different options for concatenating units into speech. One benefit of unit selection is that, depending on the size of the database, a natural sounding speech output may be generated. The larger the unit database, the more likely the TTS component 580 will be able to construct natural sounding speech.

Unit selection speech synthesis may be performed as follows. Unit selection includes a two-step process. First the TTS component 580 determines what speech units to use and then it combines them so that the particular combined units match the desired phonemes and acoustic features to create the desired speech output. Units may be selected based on a cost function which represents how well particular units fit the speech segments to be synthesized. The cost function may represent a combination of different costs representing different aspects of how well a particular speech unit may work for a particular speech segment. For example, a target cost indicates how well a given speech unit matches the features of a desired speech output (e.g., pitch, prosody, etc.). A join cost represents how well a speech unit matches a consecutive speech unit for purposes of concatenating the speech units together in the eventual synthesized speech. The overall cost function is a combination of target cost, join cost, and other costs that may be determined by the TTS component 580.

In another method of synthesis called parametric synthesis, parameters such as frequency, volume, noise, etc. are varied by the TTS component 580 to create an artificial speech waveform output. Parametric synthesis may use an acoustic model and various statistical techniques to match data, input to the TTS component 580, with desired output speech parameters. Parametric synthesis may include the ability to be accurate at high processing speeds, as well as the ability to process speech without large databases associated with unit selection, but also typically produces an output speech quality that may not match that of unit selection. Unit selection and parametric techniques may be performed individually or combined together and/or combined with other synthesis techniques to produce speech audio output.

Parametric speech synthesis may be performed as follows. The TTS component 580 may include an acoustic model, or other models, which may convert data, input to the TTS component 580, into a synthetic acoustic waveform based on audio signal manipulation. The acoustic model includes rules that may be used to assign specific audio waveform parameters to input phonetic units and/or prosodic annotations. The rules may be used to calculate a score representing a likelihood that a particular audio output parameter(s), such as frequency, volume, etc., corresponds to the portion of the input data.

The TTS component 580 may use a number of techniques to match speech to be synthesized with input phonetic units and/or prosodic annotations. One common technique is using Hidden Markov Models (HMMs). HMIs may be used to determine probabilities that audio output should match textual input. HMMs may be used to translate from parameters from the linguistic and acoustic space to the parameters to be used by a vocoder (i.e., a digital voice encoder) to artificially synthesize the desired speech. Using HMIs, a number of states are presented, in which the states together represent one or more potential acoustic parameters to be output to the vocoder and each state is associated with a model, such as a Gaussian mixture model. Transitions between states may also have an associated probability, representing a likelihood that a current state may be reached from a previous state. Sounds to be output may be represented as paths between states of the HMI and multiple paths may represent multiple possible audio matches for the same input text. Each portion of text may be represented by multiple potential states corresponding to different known pronunciations of phonemes and their parts, such as the phoneme identity, stress, accent, position, etc. An initial determination of a probability of a potential phoneme may be associated with one state. As new text is processed by the TTS component 580, the state may change or stay the same, based on the processing of the new text. For example, the pronunciation of a previously processed word might change based on later processed words. A Viterbi algorithm may be used to find the most likely sequence of states based on the processed text. The HMIs may generate speech in parametrized form including parameters such as fundamental frequency (f0), noise envelope, spectral envelope, etc. that are translated by a vocoder into audio segments. The output parameters may be configured for particular vocoders such as a STRAIGHT vocoder, TANDEM-STRAIGHT vocoder, HNM (harmonic plus noise) based vocoders, CELP (code-excited linear prediction) vocoders, GlottHMM vocoders, HSM (harmonic/stochastic model) vocoders, or others.

In addition to calculating potential states for one audio waveform as a potential match to a phonetic unit, the TTS component 580 may also calculate potential states for other potential audio outputs, such as various ways of pronouncing phoneme/E/, as potential acoustic matches for the phonetic unit. In this manner multiple states and state transition probabilities may be calculated.

The probable states and probable state transitions calculated by the TTS component 580 may lead to a number of potential audio output sequences. Based on the acoustic model and other potential models, the potential audio output sequences may be scored according to a confidence level of the TTS component 580. The highest scoring audio output sequence, including a stream of parameters to be synthesized, may be chosen and digital signal processing may be performed by a vocoder or similar component to create an audio output including synthesized speech waveforms corresponding to the parameters of the highest scoring audio output sequence and, if the proper sequence was selected, also corresponding to the input data.

The system 120 may include the user recognition component 170. The user recognition component 170 may recognize one or more users using various data. The user recognition component 170 may take as input the audio data 511. The user recognition component 170 may perform user recognition by comparing speech characteristics, in the audio data 511, to stored speech characteristics of users. The user recognition component 170 may additionally or alternatively perform user recognition by comparing biometric data (e.g., fingerprint data, iris data, retina data, etc.), received by the system 120 in correlation with a natural language user input, to stored biometric data of users. The user recognition component 170 may additionally or alternatively perform user recognition by comparing image data (e.g., including a representation of at least a feature of a user), received by the system 120 in correlation with a natural language user input, with stored image data including representations of features of different users. The user recognition component 170 may perform other or additional user recognition processes, including those known in the art. For a particular natural language user input, the user recognition component 170 may perform processing with respect to stored data of users associated with the device 110 that received the natural language user input.

The user recognition component 170 determines whether a natural language user input originated from a particular user. For example, the user recognition component 170 may determine a first value representing a likelihood that a natural language user input originated from a first user, a second value representing a likelihood that the natural language user input originated from a second user, etc. The user recognition component 170 may also determine an overall confidence regarding the accuracy of user recognition processing.

The user recognition component 170 may output a single user identifier corresponding to the most likely user that originated the natural language user input. Alternatively, the user recognition component 170 may output multiple user identifiers (e.g., in the form of an N-best list) with respective values representing likelihoods of respective users originating the natural language user input. The output of the user recognition component 170 may be used to inform NLU processing, processing performed by a skill component 160, processing performed by the access control skill component 165, as well as processing performed by other components of the system 120 and/or other systems.

The system 120 may include profile storage 570. The profile storage 570 may include a variety of data related to individual users, groups of users, devices, etc. As used herein, a “profile” refers to a set of data associated with a user, group of users, device, etc. The data of a profile may include preferences specific to the user, group of users, device, etc.; input and output capabilities of one or more devices; internet connectivity data; user bibliographic data; subscription data; skill component enablement data; and/or other data.

The profile storage 570 may include one or more user profiles. Each user profile may be associated with a different user identifier. Each user profile may include various user identifying data (e.g., name, gender, address, language(s), etc.). Each user profile may also include preferences of the user. Each user profile may include one or more device identifiers, each representing a respective device registered to the user. Each user profile may include skill component identifiers of skill components that the user has enabled. When a user enables a skill component, the user is providing permission to allow the skill component to execute with respect to the user's inputs. If a user does not enable a skill component, the skill component may be prevented from processing with respect to the user's inputs.

The profile storage 570 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, a user profile may include preferences unique from one or more other user profiles associated with the same group profile. A user profile may be a stand-alone profile or may be associated with a group profile. A group profile may be associated with (or include) one or more device profiles corresponding to one or more devices associated with the group profile.

The profile storage 570 may include one or more device profiles. Each device profile may be associated with a different device identifier. A device profile may include various device identifying data, input/output characteristics, networking characteristics, etc. A device profile may also include one or more user identifiers, corresponding to one or more user profiles associated with the device profile. For example, a household device's profile may include the user identifiers of users of the household.

In addition to the components illustrated in FIG. 5, the system 120 may include one or more of the dispatch component 135, the state management component 1555, the event component 180, the access control skill component 165, the validation skill component 175, the consent component 190, and the identity component 195.

In some embodiments, the device 110 may include the speech processing components described above with respect to the system 120, and may be configured to perform the processing described above with respect to the system 120. In such embodiments a variety of operations discussed herein may be performed by the device 110 without necessarily involving 120, for example in processing and executing a spoken command. In other embodiments the device 110 may perform certain operations and the system 120 may perform other operations in a combined effort to process and execute a spoken command.

As illustrated in FIG. 6, the user recognition component 170 may include one or more subcomponents including a vision component 608, an audio component 610, a biometric component 612, a radio frequency (RF) component 614, a machine learning (ML) component 616, and a recognition confidence component 618. In some instances, the user recognition component 170 may monitor data and determinations from one or more subcomponents to determine an identity of one or more users associated with data input to the device 110 and/or the system 120. The user recognition component 170 may output user recognition data 410, which may include a user identifier associated with a user the user recognition component 170 determines originated data input to the device 110 and/or the system 120. The user recognition data 410 may be used to inform processes performed by various components of the device 110 and/or the system 120.

The vision component 608 may receive data from one or more sensors capable of providing images (e.g., cameras) or sensors indicating motion (e.g., motion sensors). The vision component 608 can perform facial recognition or image analysis to determine an identity of a user and to associate that identity with a user profile associated with the user. In some instances, when a user is facing a camera, the vision component 608 may perform facial recognition and identify the user with a high degree of confidence. In other instances, the vision component 608 may have a low degree of confidence of an identity of a user, and the user recognition component 170 may utilize determinations from additional components to determine an identity of a user. The vision component 608 can be used in conjunction with other components to determine an identity of a user. For example, the user recognition component 170 may use data from the vision component 608 with data from the audio component 610 to identify what user's face appears to be speaking at the same time audio is captured by a device 110 the user is facing for purposes of identifying a user who spoke an input to the device 110 and/or the system 120.

The overall system of the present disclosure may include biometric sensors that transmit data to the biometric component 612. For example, the biometric component 612 may receive data corresponding to fingerprints, iris or retina scans, thermal scans, weights of users, a size of a user, pressure (e.g., within floor sensors), etc., and may determine a biometric profile corresponding to a user. The biometric component 612 may distinguish between a user and sound from a television, for example. Thus, the biometric component 612 may incorporate biometric information into a confidence level for determining an identity of a user. Biometric information output by the biometric component 612 can be associated with specific user profile data such that the biometric information uniquely identifies a user profile of a user.

The radio frequency (RF) component 614 may use RF localization to track devices that a user may carry or wear. For example, a user (and a user profile associated with the user) may be associated with a device. The device may emit RF signals (e.g., Wi-Fi, Bluetooth®, etc.). A device may detect the signal and indicate to the RF component 614 the strength of the signal (e.g., as a received signal strength indication (RSSI)). The RF component 614 may use the RSSI to determine an identity of a user (with an associated confidence level). In some instances, the RF component 614 may determine that a received RF signal is associated with a mobile device that is associated with a particular user identifier.

In some instances, a personal device (such as a phone, tablet, wearable or other device) may include some RF or other detection processing capabilities so that a user who speaks an input may scan, tap, or otherwise acknowledge his/her personal device to the device 110. In this manner, the user may “register” with the system 100 for purposes of the system 100 determining who spoke a particular input. Such a registration may occur prior to, during, or after speaking of an input.

The ML component 616 may track the behavior of various users as a factor in determining a confidence level of the identity of the user. By way of example, a user may adhere to a regular schedule such that the user is at a first location during the day (e.g., at work or at school). In this example, the ML component 616 would factor in past behavior and/or trends in determining the identity of the user that provided input to the device 110 and/or the system 120. Thus, the ML component 616 may use historical data and/or usage patterns over time to increase or decrease a confidence level of an identity of a user.

In at least some instances, the recognition confidence component 618 receives determinations from the various components 608, 610, 612, 614, and 616, and may determine a final confidence level associated with the identity of a user. In some instances, the confidence level may determine whether an action is performed in response to a user input. For example, if a user input includes a request to unlock a door, a confidence level may need to be above a threshold that may be higher than a threshold confidence level needed to perform a user request associated with playing a playlist or sending a message. The confidence level or other score data may be included in the user recognition data 410.

The audio component 610 may receive data from one or more sensors capable of providing an audio signal (e.g., one or more microphones) to facilitate recognition of a user. The audio component 610 may perform audio recognition on an audio signal to determine an identity of the user and associated user identifier. In some instances, aspects of device 110 and/or the system 120 may be configured at a computing device (e.g., a local server). Thus, in some instances, the audio component 610 operating on a computing device may analyze all sound to facilitate recognition of a user. In some instances, the audio component 610 may perform voice recognition to determine an identity of a user.

The audio component 610 may also perform user identification based on audio data 511 input into the device 110 and/or the system 120 for speech processing. The audio component 610 may determine scores indicating whether speech in the audio data originated from particular users. For example, a first score may indicate a likelihood that speech in the audio data 511 originated from a first user associated with a first user identifier, a second score may indicate a likelihood that speech in the audio data 511 originated from a second user associated with a second user identifier, etc. The audio component 610 may perform user recognition by comparing speech characteristics represented in the audio data 511 to stored speech characteristics of users (e.g., stored voice profiles associated with the device 110 that captured the spoken user input).

FIG. 7 illustrates user recognition processing as may be performed by the user recognition component 170. The ASR component 145 performs ASR processing on ASR feature vector data 750. ASR confidence data 707 may be passed to the user recognition component 170.

The user recognition component 170 performs user recognition using various data including the user recognition feature vector data 740, feature vectors 705 representing voice profiles of users of the system 100, the ASR confidence data 707, and other data 709. The user recognition component 170 may output the user recognition data 410, which reflects a certain confidence that the user input was spoken by one or more particular users. The user recognition data 410 may include one or more user identifiers (e.g., corresponding to one or more voice profiles). Each user identifier in the user recognition data 410 may be associated with a respective confidence value, representing a likelihood that the user input corresponds to the user identifier. A confidence value may be a numeric or binned value.

The feature vector(s) 705 input to the user recognition component 170 may correspond to one or more voice profiles. The user recognition component 170 may use the feature vector(s) 705 to compare against the user recognition feature vector 740, representing the present user input, to determine whether the user recognition feature vector 740 corresponds to one or more of the feature vectors 705 of the voice profiles. Each feature vector 705 may be the same size as the user recognition feature vector 740.

To perform user recognition, the user recognition component 170 may determine the device 110 from which the audio data 511 originated. For example, the audio data 511 may be associated with metadata including a device identifier representing the device 110. Either the device 110 or the system(s) 120 may generate the metadata. The system 100 may determine a group profile identifier associated with the device identifier, may determine user identifiers associated with the group profile identifier, and may include the group profile identifier and/or the user identifiers in the metadata. The system 100 may associate the metadata with the user recognition feature vector 740 produced from the audio data 511. The user recognition component 170 may send a signal to voice profile storage 785, with the signal requesting only audio data and/or feature vectors 705 (depending on whether audio data and/or corresponding feature vectors are stored) associated with the device identifier, the group profile identifier, and/or the user identifiers represented in the metadata. This limits the universe of possible feature vectors 705 the user recognition component 170 considers at runtime and thus decreases the amount of time to perform user recognition processing by decreasing the amount of feature vectors 705 needed to be processed. Alternatively, the user recognition component 170 may access all (or some other subset of) the audio data and/or feature vectors 705 available to the user recognition component 170. However, accessing all audio data 511 and/or feature vectors 705 will likely increase the amount of time needed to perform user recognition processing based on the magnitude of audio data and/or feature vectors 705 to be processed.

If the user recognition component 170 receives audio data from the voice profile storage 785, the user recognition component 170 may generate one or more feature vectors 705 corresponding to the received audio data.

The user recognition component 170 may attempt to identify the user that spoke the speech represented in the audio data 511 by comparing the user recognition feature vector 740 to the feature vector(s) 705. The user recognition component 170 may include a scoring component 722 that determines respective scores indicating whether the user input (represented by the user recognition feature vector 740) was spoken by one or more particular users (represented by the feature vector(s) 705). The user recognition component 170 may also include a confidence component 724 that determines an overall accuracy of user recognition processing (such as those of the scoring component 722) and/or an individual confidence value with respect to each user potentially identified by the scoring component 722. The output from the scoring component 722 may include a different confidence value for each received feature vector 705. For example, the output may include a first confidence value for a first feature vector 705a (representing a first voice profile), a second confidence value for a second feature vector 705b (representing a second voice profile), etc. Although illustrated as two separate components, the scoring component 722 and the confidence component 724 may be combined into a single component or may be separated into more than two components.

The scoring component 722 and the confidence component 724 may implement one or more trained machine learning models (such as neural networks, classifiers, etc.) as known in the art. For example, the scoring component 722 may use probabilistic linear discriminant analysis (PLDA) techniques. PLDA scoring determines how likely it is that the user recognition feature vector 740 corresponds to a particular feature vector 705. The PLDA scoring may generate a confidence value for each feature vector 705 considered and may output a list of confidence values associated with respective user identifiers. The scoring component 722 may also use other techniques, such as GMMs, generative Bayesian models, or the like, to determine confidence values.

The confidence component 724 may input various data including information about the ASR confidence, speech length (e.g., number of frames or other measured length of the user input), audio condition/quality data (such as signal-to-interference data or other metric data), fingerprint data, image data, or other factors to consider how confident the user recognition component 170 is with regard to the confidence values linking users to the user input. The confidence component 724 may also consider the confidence values and associated identifiers output by the scoring component 722. For example, the confidence component 724 may determine that a lower ASR confidence, or poor audio quality, or other factors, may result in a lower confidence of the user recognition component 170. Whereas a higher ASR confidence, or better audio quality, or other factors, may result in a higher confidence of the user recognition component 170. Precise determination of the confidence may depend on configuration and training of the confidence component 724 and the model(s) implemented thereby. The confidence component 724 may operate using a number of different machine learning models/techniques such as GMM, neural networks, etc. For example, the confidence component 724 may be a classifier configured to map a score output by the scoring component 722 to a confidence value.

The user recognition component 170 may output user recognition data 410 specific to a one or more user identifiers. For example, the user recognition component 170 may output user recognition data 410 with respect to each received feature vector 705. The user recognition data 410 may include numeric confidence values (e.g., 0.0-1.0, 0-1000, or whatever scale the system is configured to operate). Thus, the user recognition data 410 may output an n-best list of potential users with numeric confidence values (e.g., user identifier 123-0.2, user identifier 234-0.8). Alternatively or in addition, the user recognition data 410 may include binned confidence values. For example, a computed recognition score of a first range (e.g., 0.0-0.33) may be output as “low,” a computed recognition score of a second range (e.g., 0.34-0.66) may be output as “medium,” and a computed recognition score of a third range (e.g., 0.67-1.0) may be output as “high.” The user recognition component 170 may output an n-best list of user identifiers with binned confidence values (e.g., user identifier 123-low, user identifier 234-high). Combined binned and numeric confidence value outputs are also possible. Rather than a list of identifiers and their respective confidence values, the user recognition data 410 may only include information related to the top scoring identifier as determined by the user recognition component 170. The user recognition component 170 may also output an overall confidence value that the individual confidence values are correct, where the overall confidence value indicates how confident the user recognition component 170 is in the output results. The confidence component 724 may determine the overall confidence value.

The confidence component 724 may determine differences between individual confidence values when determining the user recognition data 410. For example, if a difference between a first confidence value and a second confidence value is large, and the first confidence value is above a threshold confidence value, then the user recognition component 170 is able to recognize a first user (associated with the feature vector 705 associated with the first confidence value) as the user that spoke the user input with a higher confidence than if the difference between the confidence values were smaller.

The user recognition component 170 may perform thresholding to avoid incorrect user recognition data 410 being output. For example, the user recognition component 170 may compare a confidence value output by the confidence component 724 to a threshold confidence value. If the confidence value does not satisfy (e.g., does not meet or exceed) the threshold confidence value, the user recognition component 170 may not output user recognition data 410, or may only include in that data 410 an indicator that a user that spoke the user input could not be recognized. Further, the user recognition component 170 may not output user recognition data 410 until enough user recognition feature vector data 740 is accumulated and processed to verify a user above a threshold confidence value. Thus, the user recognition component 170 may wait until a sufficient threshold quantity of audio data of the user input has been processed before outputting user recognition data 410. The quantity of received audio data may also be considered by the confidence component 724.

The user recognition component 170 may be defaulted to output binned (e.g., low, medium, high) user recognition confidence values. However, such may be problematic in certain situations. For example, if the user recognition component 170 computes a single binned confidence value for multiple feature vectors 705, the system may not be able to determine which particular user originated the user input. In this situation, the user recognition component 170 may override its default setting and output numeric confidence values. This enables the system to determine a user, associated with the highest numeric confidence value, originated the user input.

The user recognition component 170 may use other data 709 to inform user recognition processing. A trained model(s) or other component of the user recognition component 170 may be trained to take other data 709 as an input feature when performing user recognition processing. Other data 709 may include a variety of data types depending on system configuration and may be made available from other sensors, devices, or storage. The other data 709 may include a time of day at which the audio data 511 was generated by the device 110 or received from the device 110, a day of a week in which the audio data audio data 511 was generated by the device 110 or received from the device 110, etc.

The other data 709 may include image data or video data. For example, facial recognition may be performed on image data or video data received from the device 110 from which the audio data 511 was received (or another device). Facial recognition may be performed by the user recognition component 170. The output of facial recognition processing may be used by the user recognition component 170. That is, facial recognition output data may be used in conjunction with the comparison of the user recognition feature vector 740 and one or more feature vectors 705 to perform more accurate user recognition processing.

The other data 709 may include location data of the device 110. The location data may be specific to a building within which the device 110 is located. For example, if the device 110 is located in user A's bedroom, such location may increase a user recognition confidence value associated with user A and/or decrease a user recognition confidence value associated with user B.

The other data 709 may include data indicating a type of the device 110. Different types of devices may include, for example, a smart watch, a smart phone, a tablet, and a vehicle. The type of the device 110 may be indicated in a profile associated with the device 110. For example, if the device 110 from which the audio data 511 was received is a smart watch or vehicle belonging to a user A, the fact that the device 110 belongs to user A may increase a user recognition confidence value associated with user A and/or decrease a user recognition confidence value associated with user B.

The other data 709 may include geographic coordinate data associated with the device 110. For example, a group profile associated with a vehicle may indicate multiple users (e.g., user A and user B). The vehicle may include a global positioning system (GPS) indicating latitude and longitude coordinates of the vehicle when the vehicle generated the audio data 511. As such, if the vehicle is located at a coordinate corresponding to a work location/building of user A, such may increase a user recognition confidence value associated with user A and/or decrease user recognition confidence values of all other users indicated in a group profile associated with the vehicle. A profile associated with the device 110 may indicate global coordinates and associated locations (e.g., work, home, etc.). One or more user profiles may also or alternatively indicate the global coordinates.

The other data 709 may include data representing activity of a particular user that may be useful in performing user recognition processing. For example, a user may have recently entered a code to disable a home security alarm. A device 110, represented in a group profile associated with the home, may have generated the audio data 511. The other data 709 may reflect signals from the home security alarm about the disabling user, time of disabling, etc. If a mobile device (such as a smart phone, Tile, dongle, or other device) known to be associated with a particular user is detected proximate to (for example physically close to, connected to the same Wi-Fi network as, or otherwise nearby) the device 110, this may be reflected in the other data 709 and considered by the user recognition component 170.

Depending on system configuration, the other data 709 may be configured to be included in the user recognition feature vector data 740 so that all the data relating to the user input to be processed by the scoring component 722 may be included in a single feature vector. Alternatively, the other data 709 may be reflected in one or more different data structures to be processed by the scoring component 722.

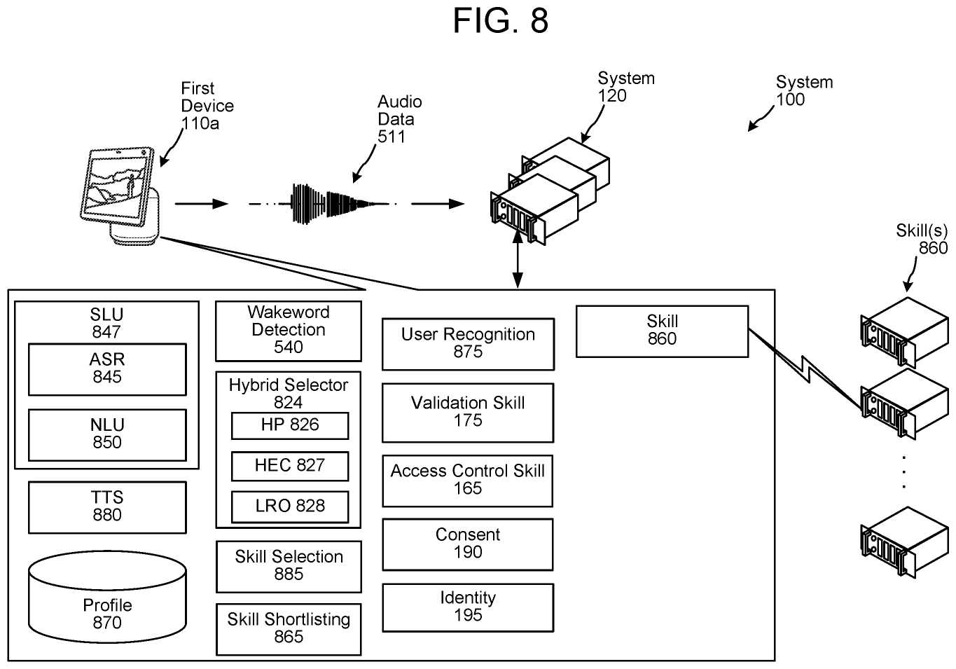

The following describes illustrative components and processing of the device 110. As illustrated in FIG. 8, in at least some embodiments the system 120 may receive the audio data 511 from the device 110, to recognize speech in the received audio data 511, and to perform functions in response to the recognized speech. In at least some embodiments, these functions involve sending directives (e.g., commands), from the system 120 to the device 110 to cause the device 110 to perform an action, such as output synthesized speech via a loudspeaker(s), and/or control one or more secondary devices by sending control commands to the one or more secondary devices.

Thus, when the device 110 is able to communicate with the system 120 over the network(s) 199, some or all of the functions capable of being performed by the system 120 may be performed by sending one or more directives over the network(s) 199 to the device 110, which, in turn, may process the directive(s) and perform one or more corresponding actions. For example, the system 120, using a directive that is included in response data (e.g., a response), may instruct the device 110 to output synthesized speech via a loudspeaker(s) of (or otherwise associated with) the device 110, to output content (e.g., music) via the loudspeaker(s) of (or otherwise associated with) the device 110, to display content on a display of (or otherwise associated with) the device 110, and/or to send a directive to a secondary device (e.g., a directive to turn on a smart light). It will be appreciated that the system 120 may be configured to provide other functions in addition to those discussed herein, such as, without limitation, providing step-by-step directions for navigating from an origin location to a destination location, conducting an electronic commerce transaction on behalf of the user 105 as part of a shopping function, establishing a communication session (e.g., an audio or video call) between the user 105 and another user, and so on.

As noted previously, the device 110 may include a wakeword detection component 540 configured to detect a wakeword (e.g., “Alexa”) that indicates to the device 110 that the audio data 511 is to be processed for determining NLU output data. In at least some embodiments, a hybrid selector 824, of the device 110, may send the audio data 511 to the wakeword detection component 540. If the wakeword detection component 540 detects a wakeword in the audio data 511, the wakeword detection component 540 may send an indication of such detection to the hybrid selector 824. In response to receiving the indication, the hybrid selector 824 may send the audio data 511 to the system 120 and/or an ASR component 845 implemented by the device 110. The wakeword detection component 540 may also send an indication, to the hybrid selector 824, representing a wakeword was not detected. In response to receiving such an indication, the hybrid selector 824 may refrain from sending the audio data 511 to the system 120, and may prevent the ASR component 845 from processing the audio data 511. In this situation, the audio data 511 can be discarded.

The device 110 may conduct its own speech processing using on-device language processing components (such as a SLU component 847, the ASR component 845, and/or a NLU component 850) similar to the manner discussed above with respect to the system-implemented SLU component 547, ASR component 145, and NLU component 150. The device 110 may also internally include, or otherwise have access to, other components such as a TTS component 880 (configured to process in a similar manner to the TTS component 580 implemented by the system 120), a profile storage 870 (configured to store similar profile data to the profile storage 570 implemented by the system 120), a skill selection component 885 (configured to process in a similar manner to the skill selection component 585 implemented by the system 120), a skill shortlisting component 865 (configured to process in a similar manner to the skill shortlisting component 565 implemented by the system 120), one or more skills 860 (configured to process in a similar manner to the one or more skills components 160 implemented by and/or in communication with the system 120), a user recognition component 875 (configured to process in a similar manner to the user recognition component 170 implemented by the system 120), the validation skill component 175, the access control skill component 165, the consent component 190, the identity component 195, and/or other components. In at least some embodiments, the profile storage 870 may only store profile data for a user or group of users specifically associated with the device 110.

In at least some embodiments, the on-device language processing components may not have the same capabilities as the language processing components implemented by the system 120. For example, the on-device language processing components may be configured to handle only a subset of the user inputs that may be handled by the system-implemented language processing components. For example, such subset of user inputs may correspond to local-type user inputs, such as those controlling components of the device 110. In such circumstances, the on-device language processing components may be able to more quickly interpret and respond to a local-type user input, for example, than processing that involves the system 120. If the device 110 attempts to process a user input for which the on-device language processing components are not necessarily best suited, the NLU output data, determined by the on-device components, may have a low confidence or other metric indicating that the processing by the on-device language processing components may not be as accurate as the processing done by the system 120.

The hybrid selector 824, of the device 110, may include a hybrid proxy (HP) 826 configured to proxy traffic to/from the system 120. For example, the HP 826 may be configured to send messages to/from a hybrid execution controller (HEC) 827 of the hybrid selector 824. For example, command/directive data received from the system 120 can be sent to the HEC 827 using the HP 826. The HP 826 may also be configured to allow the audio data 511 to pass to the system 120 while also receiving (e.g., intercepting) this audio data 511 and sending the audio data 511 to the HEC 827.

In at least some embodiments, the hybrid selector 824 may further include a local request orchestrator (LRO) 828 configured to notify the ASR component 845 about the availability of the audio data 511, and to otherwise initiate the operations of on-device language processing when the audio data 511 becomes available. In general, the hybrid selector 824 may control execution of on-device language processing, such as by sending “execute” and “terminate” events. An “execute” event may instruct a component to continue any suspended execution (e.g., by instructing the component to execute on a previously-determined intent in order to determine a directive). Meanwhile, a “terminate” event may instruct a component to terminate further execution, such as when the device 110 receives directive data from the system 120 and chooses to use that remotely-determined directive data.

Thus, when the audio data 511 is received, the HP 826 may allow the audio data 511 to pass through to the system 120 and the HP 826 may also input the audio data 511 to the ASR component 845 by routing the audio data 511 through the HEC 827 of the hybrid selector 824, whereby the LRO 828 notifies the ASR component 845 of the audio data 511. At this point, the hybrid selector 824 may wait for response data from either or both the system 120 and/or the on-device language processing components. However, the disclosure is not limited thereto, and in some examples the hybrid selector 824 may send the audio data 511 only to the ASR component 845 without departing from the disclosure. For example, the device 110 may process the audio data 511 on-device without sending the audio data 511 to the system 120.

The ASR component 845 is configured to receive the audio data 511 from the hybrid selector 824, and to recognize speech in the audio data 511, and the NLU component 850 is configured to determine an intent from the recognized speech (an optionally one or more named entities), and to determine how to act on the intent by generating directive data (e.g., instructing a component to perform an action). In some cases, a directive may include a description of the intent (e.g., an intent to turn off {device A}). In some cases, a directive may include (e.g., encode) an identifier of a second device(s), such as kitchen lights, and an operation to be performed at the second device(s). Directive data may be formatted using Java, such as JavaScript syntax, or JavaScript-based syntax. This may include formatting the directive using JSON. In at least some embodiments, a device-determined directive may be serialized, much like how remotely-determined directives may be serialized for transmission in data packets over the network(s) 199. In at least some embodiments, a device-determined directive may be formatted as a programmatic application programming interface (API) call with a same logical operation as a remotely-determined directive. In other words, a device-determined directive may mimic a remotely-determined directive by using a same, or a similar, format as the remotely-determined directive.

NLU output data (output by the NLU component 850) may be selected as usable to respond to a user input, and local response data may be sent to the hybrid selector 824, such as a “ReadyToExecute” response. The hybrid selector 824 may then determine whether to use directive data from the on-device components to respond to the user input, to use directive data received from the system 120, assuming a remote response is even received (e.g., when the device 110 is able to access the system 120 over the network(s) 199), or to determine output data requesting additional information from the user 105.

The device 110 and/or the system 120 may associate a unique identifier with each user input. The device 110 may include the unique identifier when sending the audio data 511 to the system 120, and the response data from the system 120 may include the unique identifier to identify to which user input the response data corresponds.

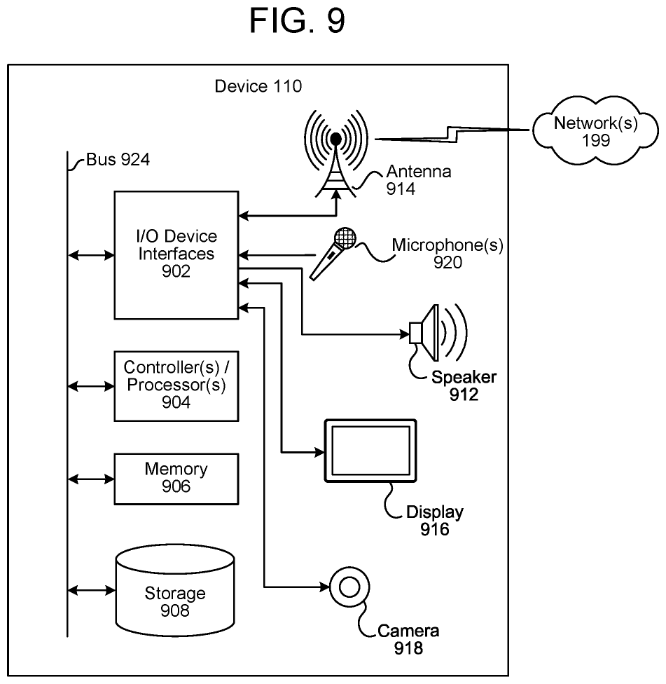

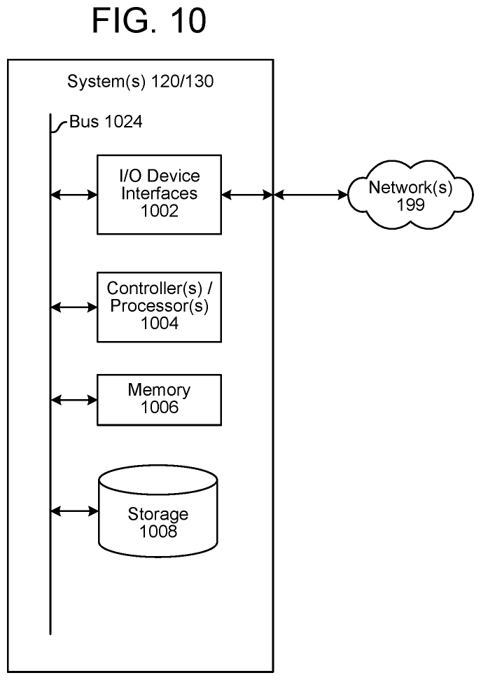

FIG. 9 is a block diagram conceptually illustrating a device 110. FIG. 10 is a block diagram conceptually illustrating example components of a remote device, such as the system 120 or access control system 130, which may assist with ASR processing, NLU processing, etc.; and a skill component. The system (120/130) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The system (120/130) may be configured to operate using one or more of a client-server model, a computer bureau model, grid computing techniques, fog computing techniques, mainframe techniques, utility computing techniques, a peer-to-peer model, sandbox techniques, or other computing techniques.

Multiple systems (120/130) may be included in the system 100 of the present disclosure, such as one or more systems 120 for performing ASR processing, one or more systems 120 for performing NLU processing, and one or more skill components, one or more access control systems 130, etc. In operation, each of these systems may include computer-readable and computer-executable instructions that reside on the respective system (120/130), as will be discussed further below.

Each of these devices (110/120/130) may include one or more controllers/processors (904/1004), which may each include a central processing unit (CPU) for processing data and computer-readable instructions, and a memory (906/1006) for storing data and instructions of the respective device. The memories (906/1006) may individually include volatile random access memory (RAM), non-volatile read only memory (ROM), non-volatile magnetoresistive memory (MRAM), and/or other types of memory. Each device (110/120/130) may also include a data storage component (908/1008) for storing data and controller/processor-executable instructions. Each data storage component (908/1008) may individually include one or more non-volatile storage types such as magnetic storage, optical storage, solid-state storage, etc. Each device (110/120/130) may also be connected to removable or external non-volatile memory and/or storage (such as a removable memory card, memory key drive, networked storage, etc.) through respective input/output device interfaces (902/1002).

Computer instructions for operating each device (110/120/130) and its various components may be executed by the respective device's controller(s)/processor(s) (904/1004), using the memory (906/1006) as temporary “working” storage at runtime. A device's computer instructions may be stored in a non-transitory manner in non-volatile memory (906/1006), storage (908/1008), or an external device(s). Alternatively, some or all of the executable instructions may be embedded in hardware or firmware on the respective device in addition to or instead of software.

Each device (110/120/130) includes input/output device interfaces (902/1002). A variety of components may be connected through the input/output device interfaces (902/1002), as will be discussed further below. Additionally, each device (110/120/130) may include an address/data bus (924/1024) for conveying data among components of the respective device. Each component within a device (110/120/130) may also be directly connected to other components in addition to (or instead of) being connected to other components across the bus (924/1024).

Referring to FIG. 9, the device 110 may include input/output device interfaces 902 that connect to a variety of components such as an audio output component such as a speaker 912, a wired headset or a wireless headset (not illustrated), or other component capable of outputting audio. The device 110 may also include an audio capture component. The audio capture component may be, for example, a microphone 920 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The device 110 may additionally include a display 916 for displaying content. The device 110 may further include a camera 918.

Via antenna(s) 914, the input/output device interfaces 902 may connect to one or more networks 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (902/1002) may also include communication components that allow data to be exchanged between devices such as different physical servers in a collection of servers or other components.

The components of the device 110, the system 120, the access control system 130, and/or a skill component may include their own dedicated processors, memory, and/or storage. Alternatively, one or more of the components of the device 110, the system 120, the access control system 130, and/or a skill component may utilize the I/O interfaces (902/1002), processor(s) (904/1004), memory (906/1006), and/or storage (908/1008) of the device(s) 110, system 120, the access control system 130, or the skill component, respectively.

As noted above, multiple devices may be employed in a single system. In such a multi-device system, each of the devices may include different components for performing different aspects of the system's processing. The multiple devices may include overlapping components. The components of the device 110, the system 120, the access control system 130, and a skill component, as described herein, are illustrative, and may be located as a stand-alone device or may be included, in whole or in part, as a component of a larger device or system.

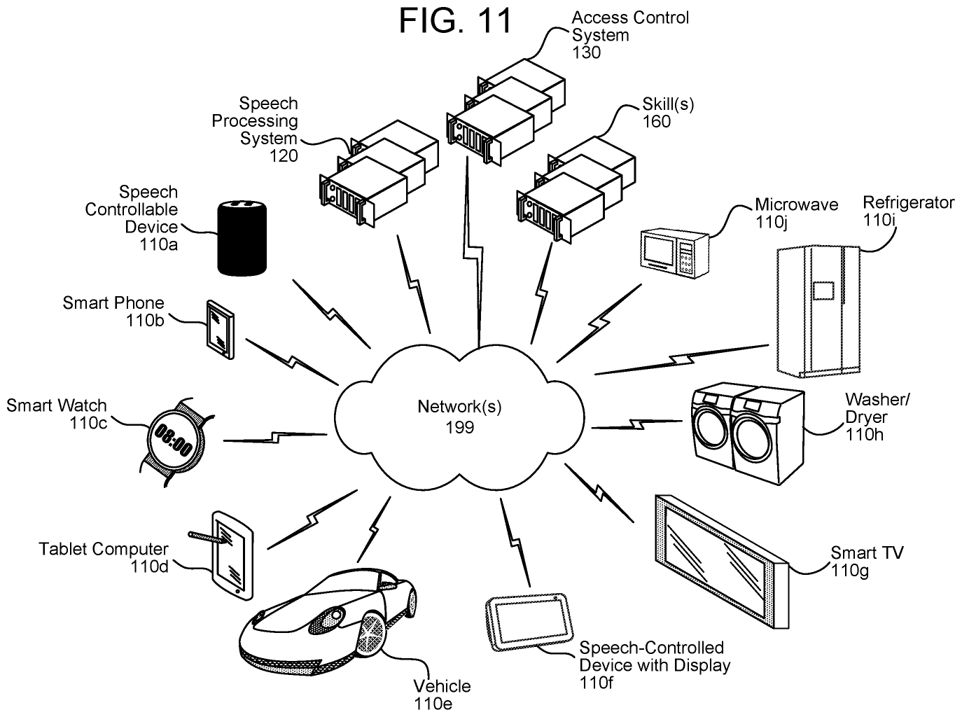

As illustrated in FIG. 11, multiple devices may contain components of the system 100 and the devices may be connected over a network(s) 199. The network(s) 199 may include a local or private network or may include a wide network such as the Internet. Devices may be connected to the network(s) 199 through either wired or wireless connections. For example, a speech controllable device 110a, a smart phone 110b, a smart watch 110c, a tablet computer 110d, a vehicle 110e, a speech-controlled device 110f with a display, a television 110g, a washer/dryer 110h, a refrigerator 110i, and a microwave 110j may be connected to the network(s) 199 through a wireless service provider, over a Wi-Fi or cellular network connection, or the like. Other devices are included as network-connected support devices, such as the system 120, the access control system 130, and/or others. The support devices may connect to the network(s) 199 through a wired connection or wireless connection. Networked devices may capture audio using one-or-more built-in or connected microphones or other audio capture devices, with processing performed by ASR components, NLU components, or other components of the same device or another device connected via the network(s) 199.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill component in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware, such as an acoustic front end (AFE), which comprises, among other things, analog and/or digital filters (e.g., filters configured as firmware to a digital signal processor (DSP)).

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computing system comprising:
at least one processor; and
at least one memory comprising instructions that, when executed by the at least one processor, cause the computing system to:
receive, from a first device associated with first profile data, first input audio data corresponding to a first spoken natural language user input;
determine, using the first input audio data, that the first spoken natural language user input requests output of a first content type;
determine the first device corresponds to a device type;
based at least in part on the first device corresponding to the device type, determine additional functionality access is required to send content, of the first content type, to the first device;
determine the additional functionality access has yet to be granted for the first device;
generate a first access token corresponding to the first profile data;
send the first access token to an access control system;
after sending the first access token to the access control system, receive, from the access control system, additional functionality access information and first data indicating the first device is capable of performing the additional functionality;
generate first output audio data:
indicating the additional functionality access is required to output the first content type,
indicating the additional functionality access information, and
requesting authorization to obtain the additional functionality access for the first device;
cause the first device to present the first output audio data;
after causing the first device to present the first output audio data, receive, from the first device, second input audio data corresponding to a second spoken natural language user input;
determine, using the second input audio data, that the second spoken natural language user input requests the additional functionality access be granted for the first device;
based at least in part on the second spoken natural language user input requesting the additional functionality access be granted for the first device, cause the access control system to grant the additional functionality access for the first device;
receive, from the access control system, second data indicating the additional functionality access has been granted for the first device;
generate second output audio data indicating the additional functionality access has been granted for the first device; and
cause the first device to present the second output audio data.

2. The computing system of claim 1, wherein the at least one memory further comprises instructions that, when executed by the at least one processor, further cause the computing system to:
after determining the additional functionality access has yet to be granted for the first device, determine a number of previous spoken natural language user inputs received from the first device and requiring the additional functionality access;
determine the number of previous spoken natural language user inputs satisfies a condition; and
based at least in part on determining the number of previous spoken natural language user inputs satisfies the condition, generate the first access token corresponding to the first profile data, wherein the access control system is configured to use the first access token to receive the first profile data, the access control system further configured to generate at least one of the additional functionality access information and first data based at least in part on the first profile data.

3. The computing system of claim 1, wherein the first content type corresponds to long-form audio, and wherein the at least one memory further comprises instructions that, when executed by the at least one processor, further cause the computing system to:
determine the additional functionality access is required to send the content, of the first content type, to the first device based at least in part on:
determining the first device corresponds to the device type, and
the first content type corresponding to the long-form audio.

4. A computing system comprising:
at least one processor; and
at least one memory comprising instructions that, when executed by the at least one processor, cause the computing system to:
receive, from a first device, first input data corresponding to a first user input;
determine the first user input requests content of a first content type;
determine a additional functionality access is required to send the content, of the first content type, to the first device;
send, to an access control system, device profile data corresponding to the first device;
after sending the device profile data, receive, from the access control system, first data indicating the first device is capable of performing the additional functionality;
based at least in part on receiving the first data, generate first output data requesting authorization to have the additional functionality access be granted for the first device;
cause the first device to present the first output data;
receive second input data corresponding to a second user input;
determine the second user input authorizes the additional functionality access be granted for the first device; and
cause the access control system to grant the additional functionality access for the first device.

5. The computing system of claim 4, wherein the at least one memory further comprises instructions that, when executed by the at least one processor, further cause the computing system to:
determine a number of previous user inputs received from the first device and requiring the additional functionality access;
determine the number of previous user inputs satisfies a condition; and
generate the first output data further based at least in part on the number of previous user inputs satisfying the condition.

6. The computing system of claim 4, wherein the at least one memory further comprises instructions that, when executed by the at least one processor, further cause the computing system to:
generate an access token corresponding to the device profile data;
send the access token to the access control system; and
after sending the access token, receive second data from the access control system, wherein the second data indicates at least one requirement for the additional functionality access to be granted for the first device.

7. The computing system of claim 4, wherein the at least one memory further comprises instructions that, when executed by the at least one processor, further cause the computing system to:
determine a user identifier associated with the second user input;
determine the user identifier is authorized to be used in granting the additional functionality access for the first device; and
cause the access control system to grant the additional functionality access for the first device based at least in part on determining the user identifier is authorized to be used in granting the additional functionality access.

8. The computing system of claim 4, wherein the at least one memory further comprises instructions that, when executed by the at least one processor, further cause the computing system to:
determine state data corresponding to the first device;
determine the state data indicates the additional functionality access has yet to be granted for the first device; and
send the device profile data to the access control system based at least in part on determining the state data indicates the additional functionality access has yet to be granted for the first device.

9. The computing system of claim 4, wherein the at least one memory further comprises instructions that, when executed by the at least one processor, further cause the computing system to:
determine the first device corresponds to a device type; and
determine the additional functionality access is required to send the content, of the first content type, to the first device based at least in part on the first device corresponding to a first device type.

10. The computing system of claim 4, wherein the first content type corresponds to long-form audio, and wherein the at least one memory further comprises instructions that, when executed by the at least one processor, further cause the computing system to:
determine the additional functionality access is required to send the content, of the first content type, to the first device based at least in part on the first content type corresponding to the long-form audio.

11. The computing system of claim 4, wherein the at least one memory further comprises instructions that, when executed by the at least one processor, further cause the computing system to:
determine an intent representing the first user input; and
determine the additional functionality access is required to send the content, of the first content type, to the first device based at least in part on the intent.

12. The computing system of claim 4, wherein the at least one memory further comprises instructions that, when executed by the at least one processor, further cause the computing system to:
receive, from the access control system, second data indicating that the additional functionality access has been granted for the first device; and
after receiving the second data, cause the first device to output the content, of the first content type.

13. A computer-implemented method comprising:
receiving, from a first device, first input data corresponding to a first user input;
determining the first user input requests content of a first content type;
determining a additional functionality access is required to send the content, of the first content type, to the first device;
sending, to an access control system, device profile data corresponding to the first device;
after sending the device profile data, receiving, from the access control system, first data indicating the first device is capable of performing the additional functionality;
based at least in part on receiving the first data, generating first output data requesting authorization to have the additional functionality access be granted for the first device;
causing the first device to present the first output data;
receiving second input data corresponding to a second user input;
determining the second user input authorizes the additional functionality access be granted for the first device; and
causing the access control system to grant the additional functionality access for the first device.

14. The computer-implemented method of claim 13, further comprising:
determining a number of previous user inputs received from the first device and requiring the additional functionality access;
determining the number of previous user inputs satisfies a condition; and
generating the first output data further based at least in part on the number of previous user inputs satisfying the condition.

15. The computer-implemented method of claim 13, further comprising:
generating an access token corresponding to the device profile data;
sending the access token to the access control system; and
after sending the access token, receiving second data from the access control system, wherein the second data indicates at least one requirement for the additional functionality access to be granted for the first device.

16. The computer-implemented method of claim 13, further comprising:
determining a user identifier associated with the second user input;
determining the user identifier is authorized to be used in granting the additional functionality access for the first device; and
causing the access control system to grant the additional functionality access for the first device based at least in part on determining the user identifier is authorized to be used in granting the additional functionality access.

17. The computer-implemented method of claim 13, further comprising:
determining state data corresponding to the first device;
determining the state data indicates the additional functionality access has yet to be granted for the first device; and
sending the device profile data to the access control system based at least in part on determining the state data indicates the additional functionality access has yet to be granted for the first device.

18. The computer-implemented method of claim 13, further comprising:
determining the first device corresponds to a device type; and
determining the additional functionality access is required to send the content, of the first content type, to the first device based at least in part on the first device corresponding to a first device type.

19. The computer-implemented method of claim 13, wherein the first content type corresponds to long-form audio, and wherein the computer-implemented method further comprises:
determining the additional functionality access is required to send the content, of the first content type, to the first device based at least in part on the first content type corresponding to the long-form audio.

20. The computer-implemented method of claim 13, further comprising:
determining an intent representing the first user input; and
determining the additional functionality access is required to send the content, of the first content type, to the first device based at least in part on the intent.
